(19) United States
(12) Patent Application Publication
(10) Pub. No.: US 2015/0377788 A1
(43) Pub. Date: Dec. 31, 2015

(54) OPTICAL SENSOR HEAD AND OPTICAL SENSOR SYSTEM

(71) Applicant: Sharp Kabushiki Kaisha, Osaka-shi, Osaka (JP)

(72) Inventors: Tazuko KITAZAWA, Osaka-shi (JP); Noboru IWATA, Osaka-shi (JP); Takanobu SATO, Osaka-shi (JP)

(21) Appl. No.: 14/766,145

(22) PCT Filed: Jan. 31, 2014
(86) PCT No.: PCT/JP2014/052304

§ 371 Date: Aug. 6, 2015

(30) Foreign Application Priority Data
Feb. 14, 2013 (JP) 2013-026891

(51) Int. Cl. G01N 21/65; G01N 21/41

(52) U.S. Cl. CPC G01N 21/658; G01N 21/41; G01N 2201/06113; G01N 2201/068; G01N 2201/08

(57) ABSTRACT

An optical sensor head detects only the refractive index inside a through hole and is not susceptible to influence from the outside of the through hole. An optical sensor head includes a light emitting device 2 in which a first reflection surface 4, a second reflection surface 5 that opposes the first reflection surface 4 and a waveguide 6 provided between the first reflection surface 4 and the second reflection surface 5 are formed; a light blocking film 7 in which a through hole 8 for generating near-field light is provided, and that is formed on the first reflection surface 4; and a detector 3 that detects the light intensity of light emitted from the light emitting device 2 through the second reflecting surface 5. The opening area of the through hole 8 on the emission surface 7b of the light of the light blocking film 7 is larger than the opening area of the through hole 8 on the opposing surface 7a of the light blocking film 7 opposing the first reflection surface 4.

### TECHNICAL FIELD

The present invention relates to an optical sensor head and an optical sensor system.

### BACKGROUND ART

In general, a method of detecting variations in the resonance state of an optical resonator in various optical sensors is used in various fields in light having high sensitivity and a marker being unnecessary. For example, in PTL 1, the returning light from an optical recording medium returns to the semiconductor laser, the oscillation state of the semiconductor laser is varied, and the variations are detected by a monitor photodetector (PD).

In PTL 2, the oscillator is formed integrally with the semiconductor laser and the monitor PD as an oscillation detector, and contributes intensity modulation to the oscillation state of the semiconductor laser through the returning light from the oscillator, and variations in the eigen frequency of the oscillator and the pressure, temperature, displacement, flow rate and the like that are sources thereof are measured by analyzing the modulation from the signal detected by the monitor PD.

In PTL 3, a recording apparatus that uses a semiconductor laser in which a metal film that is an emission window is provided in the end surface, and performs recording with near-field light that is generated with the emission window, performs reproduction of the recording medium using voltage variations arising between current injection electrodes to the semiconductor laser element or light intensity variations in the semiconductor laser element radiated from the reverse side to the end surface in which the metal film is provided due to reflection light from the recording medium of the near-field light returning to the semiconductor laser element.

Meanwhile, due to surface plasmon resonance (resonance of the incident light and vibration of electrons in a metal), a surface plasmon sensor that detects the refractive index of the surface of a metal film is mainly used in research applications in the field of biology in light of having high sensitivity and a marker being unnecessary.

In a method generally using the sensor, light is collected via a prism with respect to a metal film provided on one surface of the prism, thereby becoming incident, the reflected light is detected, and the refractive index of the surface of the metal film is analyzed from the angle of incidence at which the light is absorbed. Ordinarily, the molecular concentration of the molecule is converted from the refractive index by providing an adsorption layer that adsorbs specified molecules in the metal film.

However, because a complex configuration formed from a light source, lens, prism and the like is necessary in executing this method, precision during assembly, strict temperature management so that variations over time do not occur, correction of shifts that arise and the like are necessary, costs are incurred, and the size of the apparatus increases. High precision detection on the molecular level is difficult.

In contrast, a method using a resonator is proposed in order to reduce size and perform highly sensitive detection. In PTL 4, a microresonator is assembled to one portion of the planar waveguide, and variations in the spectral response due to the refractive index variations in the microresonator surface are detected. The microresonator is formed from a metallic thin film, and the reflection part uses distributed Bragg reflector (DBR) reflection due to the periodic structure and is a resonator for surface plasmon waves.

PTL 5 discloses a localized surface plasmon sensor in which a metal fine particle layer with dimensions at which the localized surface plasmon resonance is excited is formed on the end surface of an optical fiber, and a molecular layer of a complementary molecule to the detection target molecule is formed on the on the surface of the metal fine particle layer. The localized surface plasmon sensor uses variations in light reflected or scattered from the end surface of an optical fiber, and detects the detection target molecules adsorbed or bonded to the complementary molecule.

### CITATION LIST

### Patent Literature

PTL 1: Japanese Unexamined Patent Application Publication No. 9-237914 (Laid open 9 Sep. 1997)

PTL 2: Japanese Unexamined Patent Application Publication No. 6-117913 (Laid open 28 Apr. 1994)

PTL 3: Japanese Unexamined Patent Application Publication No. 2001-266389 (Laid open 28 Sep. 2001)

PTL 4: Japanese Unexamined Patent Application Publication (Translation of PCT Application) No. 2007-537439 (Laid open 20 Dec. 2007)

PTL 5: Japanese Patent No. 4224641 (Published 18 Feb. 2009)

### SUMMARY OF INVENTION

### Technical Problem

However, in PTL 1, because the optical recording medium and the semiconductor lasers are separate bodies, and because high precision adjustment is necessary and a structure should be used that prevents positional shifting due to variations over time in order for the necessary light amount to return to the semiconductor laser in reproduction, cost increases are incurred. In PTL 2, a high aspect ratio oscillator should be formed close to the semiconductor laser and on the same substrate, and precision is demanded in masking and etching. Because the eigen frequency should be detected, the signal processing after detection is complex.

In PTL 4, because a 2 to 10 micron long resonator is used, loss of the surface plasmon wave that is a damped wave occurs inside the resonator, and there are no prospects for improvements in the sensitivity. There is a boundary to size reductions of the portion necessary for a separate light source.

The technology in PTL 3 reproduces reflectivity variations in the near-field light in the recording medium at a position separated from the metal film with the emission window, and uses the near-field light that spreads from the emission window to the outside. In this method, the configuration is influenced from the outside of the through hole. In detecting the molecular level, there is a problem of the detection ranged being too wide.

In the sensor disclosed in PTL 5, because a resonator is not used, the sensitivity is low. In this sensor, loss of light intensity occurs when the light of the light source is joined to the optical fiber.

The present invention provides an optical sensor system capable of high sensitivity and size reductions, an optical sensor head with good sensitivity, capable of size reductions, with almost no influence from the outside of a through hole and further without an excessively wide detection range, and an optical sensor system including the same.

### Solution to Problem

According to an aspect of the invention, an optical sensor system of the present invention includes a light emitting device that includes a first reflection surface, a second reflection surface that opposes the first reflection surface and a waveguide provided between the first reflection surface and the second reflection surface; a reactant formed on the first reflection surface; a first detector that detects a light intensity of light emitted from one of the first reflection surface and the second reflection surface; and a calculator that calculates environmental parameters in the first reflection surface based on the light intensity detected by the first detector. The reflectivity R₁ of the first reflection surface and the light intensity P(R₁) detected by the detector satisfy the following relationship.

$$\vert \frac{d P ( {R}_{1} )}{d {R}_{1}} \vert > P ( {R}_{1} ) \qquad [ Math . 1 ]$$

According to another aspect of the invention, an optical sensor head of the present invention includes a light emitting device in which a first reflection surface, a second reflection surface that opposes the first reflection surface and a waveguide provided between the first reflection surface and the second reflection surface is formed; a light blocking film in which a through hole for generating near-field light is provided, and that is formed on the first reflection surface; and a detector that detects the light intensity of light emitted from the light emitting device through the first or second reflecting surface, in which an opening area of the through hole on the emission surface of light of the light blocking film is larger than the opening area of the through hole on the opposing surface of the light blocking film opposing the first reflection surface.

### Advantageous Effects of Invention

According to optical sensor system according to the first aspect, the sensitivity may be increased and the size may be reduced compared to an optical sensor system of the related art. Here, the optical sensor system of the related art signifies a “system that detects a variation amount of an environmental parameter from reflected light or transmitted light when a reactant is irradiated with light” and the details thereof will be described later.

According to the optical sensor head according to the second aspect, because the intensity distribution of light in the through hole becomes weak in the vicinity of the emission surface of light and becomes strong in the vicinity of the opposing surface of light, detection may not easily influenced influence from the outside of the through hole and may be performed with a favorable sensitivity of only variations in the refractive index inside the through hole. Therefore, detection may be performed on the molecular level if the opening size in the opposing surface of the through hole is made sufficiently small. In order to detect only the detection target able to enter the opening in the opposing surface of the through hole, detection may be performed after sorting the detection target with the opening size. Since the detection target may only be present inside the through hole, the sample volume may be reduced. The size may be reduced because a separate light source is made unnecessary.

### BRIEF DESCRIPTION OF DRAWINGS

FIG. 1 is a schematic view of an optical sensor system according to Embodiment 1 of the invention.

FIG. 2 is a graph showing the light emission characteristics (reflectivity of the reflection surface and relationship between the differential efficiency and the threshold voltage) of a light emitting device included in the optical sensor system depicted in FIG. 1.

FIG. 3 is a graph showing the light emission characteristics (reflectivity of the reflection surface and relationship between the intensities of light radiated from the two reflection surfaces) of a light emitting device included in the optical sensor system depicted in FIG. 1.

FIG. 4 is a graph showing the light emission characteristics (relationship between reflectivity of the reflection surface and value in which the intensities of light radiated from the two reflection surfaces are differentiated by reflectivity) of a light emitting device included in the optical sensor system depicted in FIG. 1.

FIG. 5 is a perspective view of an optical sensor head according to Embodiment 2 of the invention.

FIG. 6 is a cross-sectional view showing a through hole formed in the light blocking film in the optical sensor head shown in FIG. 5.

FIGS. 7(a) to 7(c) are photographs showing the FDTD simulation results in three types of optical sensor head that include an optical sensor head shown in FIG. 5.

FIGS. 7(d) to 7(f) are photographs showing the FDTD simulation results in a case where the polarization direction of light emitted from the light emitting device is different to that in FIGS. 7(a) to 7(c).

FIG. 7(g) is a graph showing the intensity distribution from the opposing surface to the emission surface in each example in FIGS. 7(d) to 7(f).

FIG. 8 is a diagram drawing showing the characteristics of the optical sensor head shown in FIG. 5.

FIG. 9 is a schematic perspective view of a flow channel member able to be attached to the optical sensor head shown in FIG. 5.

FIG. 10 is a cross-sectional view corresponding to FIG. 6 of the optical sensor head according to a modification example of Embodiment 2 of the invention.

FIG. 11 is a perspective view of an optical sensor head according to another modification example of Embodiment 2 of the invention.

FIG. 12 is a perspective view of an optical sensor system according to Embodiment 3 of the invention.

### DESCRIPTION OF EMBODIMENTS

### Embodiment 1

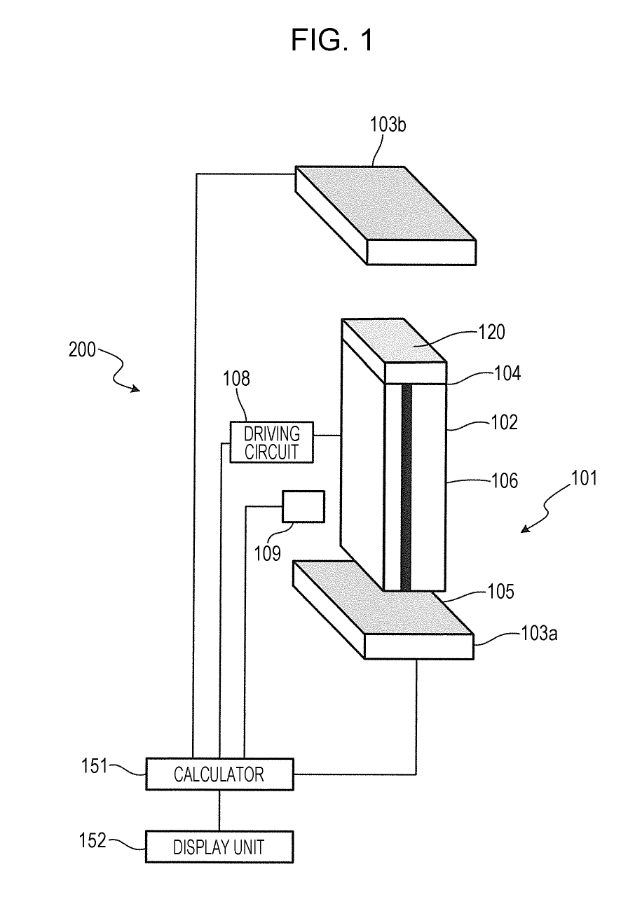

The optical sensor system according to Embodiment 1 of the invention and the examples thereof will be described with reference to FIGS. 1 to 4.

### [Configuration of Optical Sensor System]

The optical sensor system 200 according to the embodiment, as shown in FIG. 1, is configured from a light emitting device 102, a reactant 120, two detectors 103a and 103b, a driving circuit 108, a calculator 151, and a display unit 152. The light emitting device 102, reactant 120, and detectors 103a and 103b configure the optical sensor head 101. Although not shown in the drawings, the optical sensor head 101 is integrated by being packaged. The light emitting device 102 includes a first reflection surface 104, a second reflection surface 105 opposing the first reflection surface 104, and a waveguide 106 provided between the first reflection surface 104 and the second reflection surface 105. The reactant 120 is formed on the first reflection surface 104. The two detectors 103a and 103b are arranged at a position that interposes the light emitting device 102 and the reactant 120 in a direction that follows the waveguide 106, and the upper surface of the detector 103a opposes the second reflection surface 105 and the lower surface of the detector 103b opposes the upper surface of the reactant 120. As described later, only one of either of the two detectors 103a and 103b may be arranged. The driving circuit 108 is connected to the calculator 151 and two electrodes, not shown, of the light emitting device 102, and supplies an injection current to the light emitting device 102 via the two electrodes.

The light emitting device 102 is configured provided with a first reflection surface 104 and a second reflection surface 105 on both ends of the waveguide 106, and light reciprocates in the waveguide 106 between the first reflection surface 104 and the second reflection surface 105. Gain is present in the waveguide 106, the light reciprocated by the waveguide 106 is energy amplified by the gain, and a portion of the light is radiated to the outside from the first reflection surface 104 and the second reflection surface 105. In this way, the light emitting device 102 configures a resonator by including the first reflection surface 104, the second reflection surface 105, and the waveguide 106.

Specifically, a commercially available laser element may be used as the light emitting device 102, and a semiconductor laser element is particularly preferable in order to achieve size reductions. In order to increase the sensitivity, a distributed feedback laser element may be used.

The first reflection surface 104, the second reflection surface 105, and the waveguide 106 are already provided in a commercially available laser element (such as a semiconductor laser element). However, in the optical sensor system 200 according to the embodiment, because the reactant 120 is formed on the first reflection surface 104, the reflectivity of the first reflection surface 104 differs from when made commercially available.

The detectors 103a and 103b may be small and low cost commercially available photodetectors. The detection surfaces of the detectors 103a and 103b may be slightly inclined with respect to the optical axis so that detected light is reflected so as to not return to the light source. Although the detector 103a is arranged directly to the rear of the second reflection surface 105 of the light emitting device 102 in FIG. 1 and is configured to detect the light intensity of light transmitted through the second reflection surface 105, the detector 103a may be arranged anywhere as long as it is a position able to detect the intensity of light transmitted through the second reflection surface 105. Similarly, the detector 103a may be arranged anywhere as long as it is a position able to detect the light intensity of light transmitted through the first reflection surface 104 and the reactant 120.

Incidentally, the commercially available semiconductor laser element is provided with an optical detector (such as a photodiode) that monitors the light intensity of emitted light of the semiconductor laser element on the inside thereof in order to hold the light output of the semiconductor laser element constant. In a case of using a commercially available semiconductor laser element as the light emitting device 102, a photodetector may be used as the detector 103a. In so doing, it is possible to easily prepare the optical sensor system 200.

The reactant 120 formed on the first reflection surface 104 of the light emitting device 102 varies its own optical properties according to environmental parameters detected by the optical sensor system 200. Examples of the optical properties include the dielectric constant and the refractive index (including the absorption coefficient). The optical properties are ones that may vary according to the dielectric constant or the refractive index (for example, transmissivity, reflectivity, absorptivity, electrical conductivity or band gap).

The reactant 120 may be a thin film, or may be an aggregation of fine particles (for example, metal fine particles that excite surface plasmons), the shape thereof is not important. The material of the reactant 120 may be selected, as appropriate, from a dielectric, a semiconductor, a metal, an organic film or the like according to the environmental parameters. Because the optical properties of the oxide itself vary according to the oxygen content of the periphery, it is possible to use a reactant formed with an oxide in a reduction gas concentration detector, or a concentration detector of an oxidized or reduction liquid. Because the optical properties vary due to pressure, the material used in the piezoelectric element is able to detect pressure applied to the reactant using the reactant formed with the material. If an organic film that is bonded only to a specified substance is used, it is possible to detect the concentration of the specified substance.

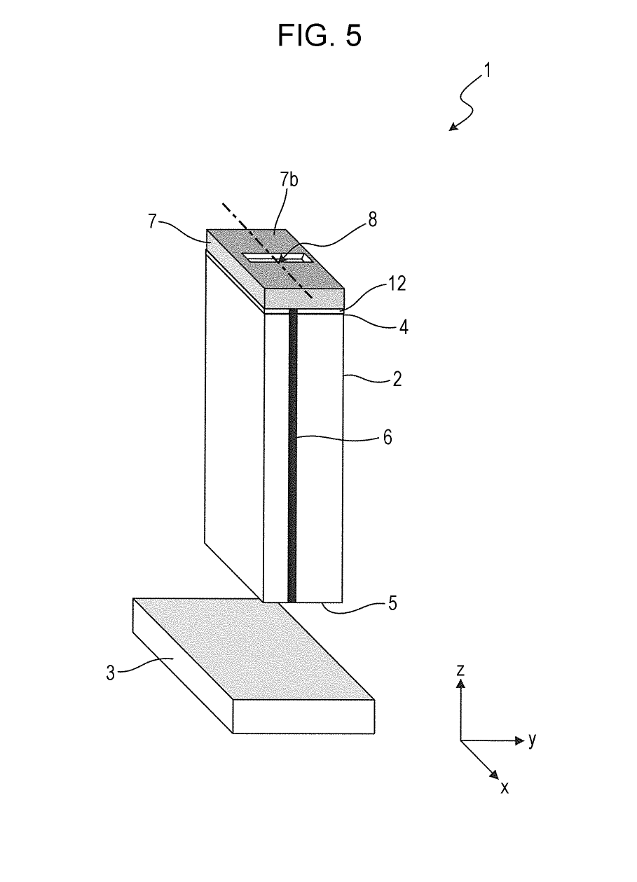

When the material of the reactant 120 is a metal, it is preferable that the reactant 120 has a shape able to excite surface plasmons. In this case, even if the reactant 120 itself does not react, the excitation conditions of the surface plasmons vary by the refractive index of the periphery according to the environmental parameters, and the reflectivity of the first reflection surface 104 varies. As a shape able to excite surface plasmons, as long as the light blocking film (refer to FIG. 5) is provided with a through hole, there is little influence from the outside of the through hole, and information of only the part in which the through hole is provided is obtained. In particular, it is preferable to make the opening size of the through hole shorter than the wavelength of light emitted from the light emitting device 102, and in this case, because almost no light is transmitted through the reactant 120, there is almost not influence from returning light. The light blocking film in which the through hole is provided will be described in detail later.

In the description, examples of the environmental parameters include the temperature, humidity, pressure, oxidation or reduction power, or the type, concentration or quantity of gases, liquids or solids present around the reactant 120.

The calculator 151 calculates the environmental parameters in the first reflection surface 104 by performing analysis based on the light intensity of light detected by the either or both of the first detector 103a and the second detector 103b. Because there are cases where the driving conditions of the light emitting device 102 are also necessary in the analysis, the calculator 151 is connected to a driving circuit 108 of the light emitting device 102 as shown in FIG. 1.

The display unit 152 displays the calculation results from the calculator 151. The display unit 152 may use a commercially available display, or may display only the numerals of the environmental parameters. In a case of using a computer as the calculator 151, if a computer-compliant display is used as the display unit 152, it is possible for the environmental parameters to be displayed as a graph on the display. In a case of using a computer as the calculator 151, it is possible for a user to input the measurement conditions or the analysis content using an input device such as a keyboard. If the calculation results of the calculator 151 are connected to another device, the display unit 152 becomes unnecessary.

The optical sensor system 200 according to the embodiment further includes a temperature sensor 109 arranged in the vicinity of the light emitting device 102. In a case of environmental parameters or the light emitting device 102 having temperature dependency, if the temperature of the light emitting device 102 is detected by the temperature sensor 109, the calculator 151 compensates for the variations in the detection signal of the light emitting device 102 based on the temperature thereof.

[Implementation Example with Software]

The calculator 151 may be realized as a logical circuit (hardware) formed in an integrated circuit (IC chip) or the like, or may be realized by software using a central processing unit (CPU). In the latter case, the calculator 151 includes a CPU that executes the commands of a program that is software that realizes various functions. The calculator 151 further includes a read only memory (ROM) or recording device (these are referred to as “recording media”) in which the programs or various data are recorded to be readable by a computer (or CPU), a random access memory (RAM) in which the program is expanded, and the like. The functions of the calculator 151 are realized by the computer (or CPU) reading and executing the program from the recording medium.

It is possible to use a “non-transitory tangible media”, such as a tape, a disk, a card, a semiconductor memory and a programmable logical circuit, as the recording medium. The program may be supplied to the computer via an arbitrary transport medium (such as a communication network or broadcast wave) able to transfer the program. The program is able to be electronically transferred in the form of a data signal embedded in a carrier wave.

### [Method of Manufacturing of Optical Sensor Head]

Next, an example of a method of manufacturing of an optical sensor head 101 shown in FIG. 1 will be described.

A commercially available laser element is used as the light emitting device 102 and a reactant 120 is formed on the first reflection surface 104 thereof. Next, the commercially available photodetectors are arranged at the positions described above as the detectors 103a and 103b, so as to be able to detect the light intensities of the light emitted to the outside through the second reflection surface 105 and the first reflection surface 104, respectively. An external resonator may be added to the commercially available laser element, and the reflection surface thereof may form the first reflection surface 104.

It is possible to form the reactant 120 on the first reflection surface 104 of the light emitting device 102 by deposition or chemical synthesis. If the reactant 120 is a conductive material, when the reactant 120 is formed on the entire surface of the first reflection surface 104, because the electrodes of the light emitting device 102 short circuit, the reactant 120 may be formed on only the part from which light is emitted in the first reflection surface 104. In this case, the reactant 120 may be formed as a film after masking a portion of the first reflection surface 104.

In a case of using a semiconductor laser element as the light emitting device 102, it is possible to use a type in which a semiconductor laser element and a photodetector that monitors the light emission intensity from the rear surface of the semiconductor laser element are packaged, and possible to manufacture an optical sensor head 101 using existing technology simply by forming a reactant 120 on the emission surface (first reflection surface 104).

### [Operation of Optical Sensor System]

Next, the analysis and calculation principles of the environmental parameters based on the light intensity of the light detected by either or both of the detector 103a and the detector 103b performed by the calculator 151. In the following description, the light emitting device 102 is a semiconductor laser element.

### <Usage Example of Semiconductor Laser Element>

As described above, the optical properties around the reactant 120 or of the reactant 120 itself vary according to variations in the environmental parameters, and the reflectivity of the first reflection surface 104 varies. First, variations in the reflectivity of the first reflection surface 104 will be described based on the calculation of the influence exerted on the light emission intensity of the semiconductor laser element that is the light emitting device 102.

The operation of the semiconductor laser element generally represented by the following expressions (1) to (3) is known. Each parameter in the expressions (1) to (3) is as follows.

η₁: differential efficiency of light radiated from first reflection surface 104
η₂: differential efficiency of light radiated from second reflection surface 105
Ith: threshold current
R₁: reflectivity of first reflection surface 104
R₂: reflectivity of second reflection surface 105
T₁: transmissivity of first reflection surface 104
T₂: transmissivity of second reflection surface 105
ηₛₜₘ: differential efficiency of inside
ηi: quantum efficiency of inside
αᵢₙₜ: internal loss
J₀: transparency current
Π: optical confinement coefficient of active layer
h: Planck constant
v: frequency of light
q: load of electron
L: resonator length
W: width of active layer
d: thickness of active layer

$$\begin{matrix}[ Math . 2 ] & \\ {η}_{1} = {η}_{stm} \frac{{T}_{1}}{2 - {R}_{1} - {R}_{2}} \frac{\frac{1}{2 L} ln \frac{1}{{R}_{1} {R}_{2}}}{{α}_{int} + \frac{1}{2 L} ln \frac{1}{{R}_{1} {R}_{2}}} \frac{hv}{q} & ( 1 ) \\ [ Math . 3 ] & \\ {η}_{2} = {η}_{stm} \frac{{T}_{2}}{2 - {R}_{1} - {R}_{2}} \frac{\frac{1}{2 L} ln \frac{1}{{R}_{1} {R}_{2}}}{{α}_{int} + \frac{1}{2 L} ln \frac{1}{{R}_{1} {R}_{2}}} \frac{hv}{q} & ( 2 ) \\ [ Math . 4 ] & \\ Ith = LW \cdot \frac{d}{{η}_{i} Γ} ( {α}_{i} + \frac{1}{2 L} ln \frac{1}{{R}_{1} {R}_{2}} ) + {J}_{0} \frac{d}{{η}_{i}} & ( 3 )\end{matrix}$$

Here, the light intensity of light radiated from the first reflection surface 104 and the second reflection surface 105 may each be detected using both of the two detectors 103a and 103b, or the light intensity of light radiated from the first reflection surface 104 or the second reflection surface 105 using only one of the two detectors 103a and 103b. That is, only one of either of the two detectors 103a and 103b may be arranged.

The light emission intensity P of the semiconductor laser element being represented by a linear relationship as shown in the following expression (4) using the differential efficiency η₁ of light radiated from the first reflection surface 104 or the differential efficiency η₂ of the light radiated from the second reflection surface 105, when the injection current I is the threshold current Ith or more is known.

[Math. 5]

P₁=η₁(I−Ith)

P₂=η₂(I−Ith) (4)

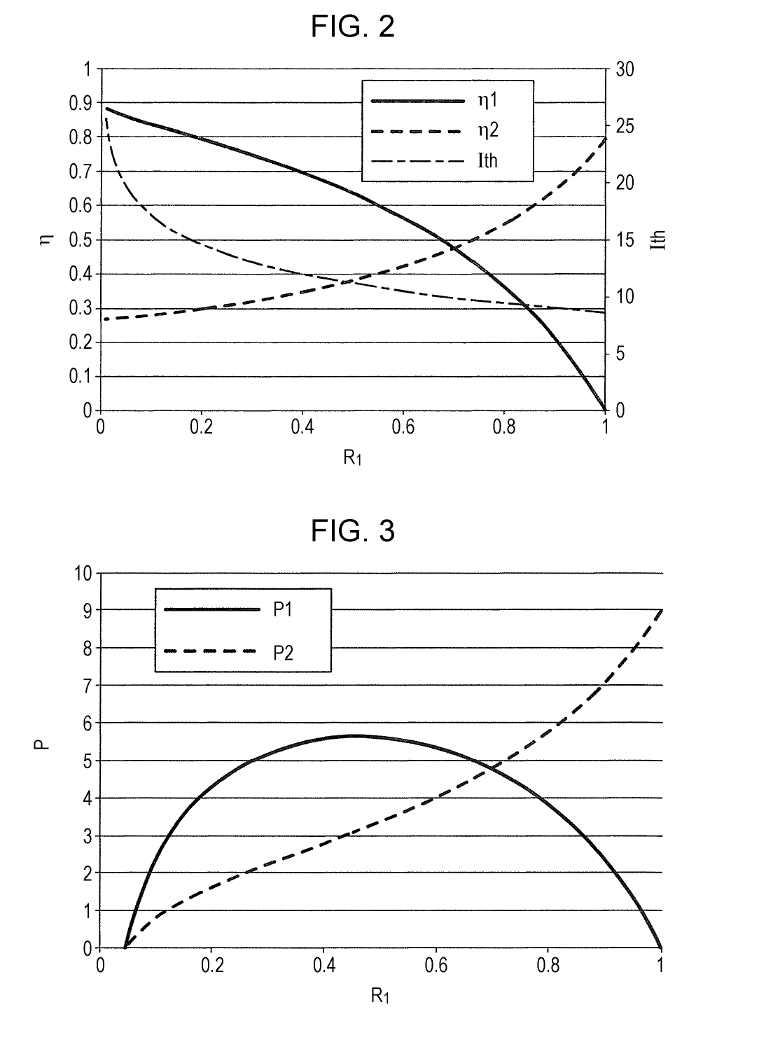

FIG. 2 is a graph showing the differential efficiencies η₁ and η₂ of light radiated from the first reflection surface 104 and the second reflection surface 105 and the condition of the variations in threshold current Ith when the reflectivity R₁ of the first reflection surface 104 in the light emitting device 102 is varied. In the characteristics shown in FIG. 2, parameters a representative semiconductor laser element with a wavelength of 785 nm has are used. R₂ of the second reflection surface 105 is fixed at 0.7.

As shown in FIG. 2, it is found that as the reflectivity R₁ of the first reflection surface 104 increases, the differential efficiency η₁ of light radiated from the first reflection surface 104 decreases, and the differential efficiency η₂ of the light radiated from the second reflection surface 105 increases. It is found that as the reflectivity R₁ of the first reflection surface 104 increases, the threshold current Ith decreases.

Based on these values, the results in which the light intensity P₁ of light radiated from the first reflection surface 104 and the light intensity P₂ of light radiated from the second reflection surface 105 are calculated when the injection current is set to 20 mA are shown in FIG. 3. The reflectivity R₁ of the first reflection surface 104 not having a value at 0.05 or less is because the threshold current is 20 mA or more in this range, and because laser oscillation does not arise when the injection current is 20 mA.

As can be seen from FIG. 3, the light intensity P₁ of light radiated from the first reflection surface 104 attains an extremely large value when the reflectivity R₁ is 0.45, and lowers as the reflectivity R₁ becomes greater than 0.45. This is because as the reflectivity R₁ becomes larger, both the threshold current Ith and the differential efficiency η₁ lower. Meanwhile, the light intensity P₂ of light radiated from the second reflection surface 105 monotonously increases as the reflectivity R₁ of the first reflection surface 104 increases. This is because as the reflectivity R₁ becomes larger, the threshold current Ith lowers, whereas the differential efficiency η₂ increases.

In the optical sensor system 200 according to the embodiment, when the reflectivity R₁ of the first reflection surface 104 varies, at least one of the light intensity P₁ of light radiated from the first reflection surface 104 and the light intensity P₂ of light radiated from the second reflection surface 105 is detected using either or both of the detector 103a and the detector 103b. The calculator 151 calculates the reflectivity R₁ of the first reflection surface 104 based the graph depicted in FIG. 3 or an equivalent relational function from either or both of the light intensity P₁ and P₂ of light detected. The calculator 151 further calculates the variation amount in the environmental parameter in the first reflection surface 104 in which the reflectivity R₁ of the first reflection surface 104 is varied based on the obtained reflectivity R₁.

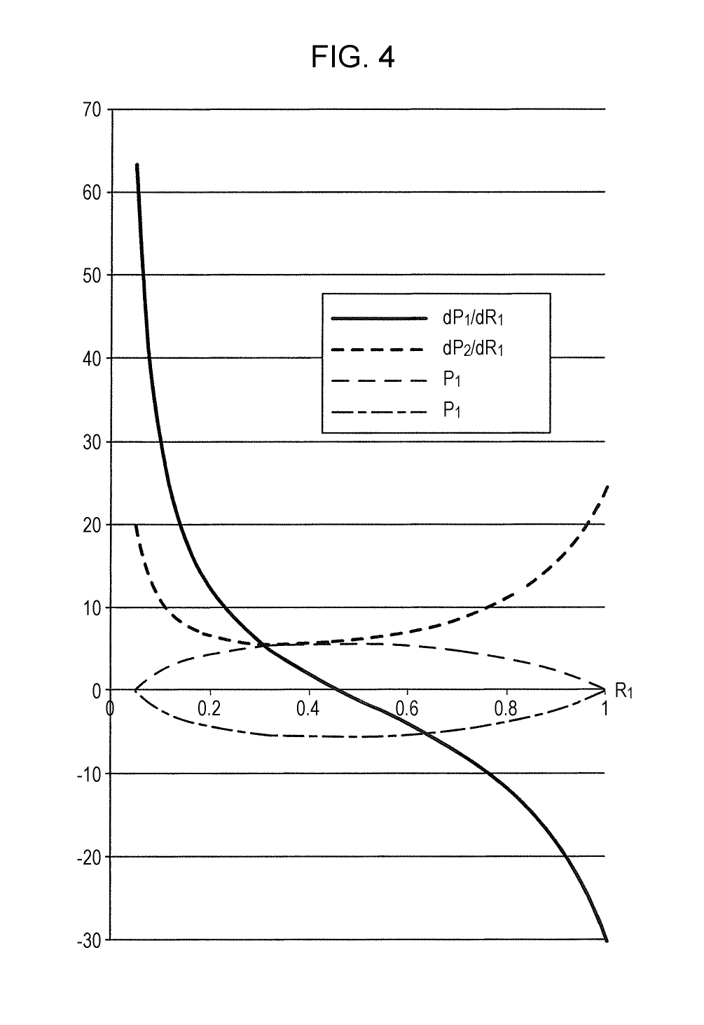

FIG. 4 shows the relationship between the reflectivity R₁ of the first reflection surface 104 and the values dP₁/dR₁ and dP₂/dR₁ in which the light intensity P₁ of light radiated from the first reflection surface 104 and the light intensity P₂ of light radiated from the second reflection surface 105 are each differentiated with the reflectivity R₁ of the first reflection surface 104 obtained based on FIG. 3. These values dP₁/dR₁ and dP₂/dR₁ correspond to the sensitivity with respect to the variation amount of the reflectivity R₁ of the first reflection surface 104 and the second reflection surface 105 in the optical sensor system 200 according to the embodiment.

That is, in measuring the sensitivity, a difference in the light intensities detected by either or both of the detector 103a and the detector 103b with respect to minute variations in the reflectivity of the first reflection surface 104 may be obtained. In the reflectivity of the first reflection surface 104 being varied, there is a means that forms a film (with a refractive index and film thickness known in advance) on the reactant 120 and in which a gas or a liquid flows on the surface of the first reflection surface 104. The reflectivity of the first reflection surface 104 at this time may be measured from the outside using a commercially available reflectivity measuring device.

Here, the optical sensor system of the related art, that is, “a system that detects a variation amount in environmental parameters from reflected light or transmitted light when a reactant is irradiated with light” will be simply described. The optical sensor system of the related art is configured so that the reactant is isolated from the light emitting device. When the transmissivity and the reflectivity of the reactant are T₁ and R₁, respectively, and the light intensity of light illuminating the reactant is P₀, the light intensity of light transmitted through the reactant is P₀T₁=P₀ (1−R₁), and the light intensity of light reflected by the reactant is P₀R₁. Accordingly, the sensitivity in the optical sensor system of the related are, that is “how much the light intensity depends on variations in the reflectivity R₁ according to varying of the optical properties (for example, refractive index) of the reactant” is represented by

d(P₀R₁)/dR₁=P₀

in a case of reflection, and

d{P₀(1−R₁)}/dR₁=−P₀

in a case of transmission.

In contrast, in the optical sensor system 200 according to the embodiment, because variations in the optical properties of the reactant 120 are fed back to the light emitting device (resonator) 102 by the reactant 120 contacting the first reflection surface 104 of the light emitting device 102, the light intensity P does not become constant, and the light intensity P varies as the reaction of the reactant 120 proceeds. When the optical properties are the reflectivity R₁ that varies according to variations in the refractive index, the light intensity P₀ of light with which the reactant 120 is irradiated is (P₀=P(R₁)) in which P(R₁), which is not constant, is represented.

Thus, in conditions where reactants having the same properties as one another are irradiated with light radiated from light emitting devices having the same properties as one another, the optical sensor system 200 of the embodiment is able to detect the environmental parameters with higher sensitivity than the optical sensor system of the related art described above as long as the absolute value of the sensitivity dP₁/dR₁ and dP₂/dR₁ is P(R₁) or higher (refer to the following formula (5)).

FIG. 4 shows P(R₁) and −P(R₁) depicted in FIG. 3 and dP₁/dR₁ and dP₂/dR₁. Referring to FIG. 4, the range of the reflectivity R₁ established by the following formula (5) is found.

$$\begin{matrix}[ Math . 1 ] & \\ \vert \frac{d P ( {R}_{1} )}{d {R}_{1}} \vert > P ( {R}_{1} ) & ( 5 )\end{matrix}$$

The parameters related to formula (5) other than reflectivities R₁ and R₂ stipulated by the coating material and the film thickness on the reflection surfaces 104 and 105 the injection current I to the light emitting device 102 are as follows.

ηₛₜₘ: differential efficiency of inside
ηᵢ: quantum efficiency of inside
αᵢₙₜ: internal loss
J₀: transparency current
Π: optical confinement coefficient of active layer
L: resonator length
W: width of active layer
d: thickness of active layer
λ: wavelength of light emitted by light emitting device 102

Among these, only the injection current I is capable of control when the optical sensor system 200 is driven. The range of the injection current I established by formula (5) is calculated in advance from FIG. 4 based on either or both of the light intensities P₁ and P₂ measured by either or both of the detectors 103a and 103b at the same time as the reflectivity R₁ is measured by the above-described reflectivity measuring device, and the range is stored in the storage unit in the calculator 151. When the environmental parameters are calculated, the injection current I having a value within the stored range is supplied to the light emitting device 102. That is, in establishing formula (5) in the optical sensor system 200 of the embodiment, the driving circuit 108 is able to control the value of the injection current to be within the appropriate range.

Because the optical sensor system of the embodiment not only has a higher sensitivity than the optical sensor system of the related art described above, but also has a reactant formed on the first reflection surface of the light emitting device, optical modulation is unnecessary and variations over time, such as position shifting, do not occur. Thus, costs are reduced by the amount that the manufacturing steps are reduced and the positional shifting countermeasures are unnecessary. In a case in which the detection signal of the first detector is able to rise sharply, the detection speed increases.

In a case of being configured so that the detectors 103a and 103b detect only a portion of the light radiated from the light emitting device 102, the calculator 151 may use the compensation coefficient in which the ratio of the total light amount radiated from the light emitting device 102 and the detected light amount is determined, and may compensate the reflectivity or refractive index calculated. In this case, the storage unit included in the calculator 151 may store the compensation coefficient.

In calculating the environmental parameters in the first reflection surface 104 from the calculated reflectivity R₁ of the first reflection surface 104, any number of sets of the environmental parameters in the first reflection surface 104 and the reflectivity R₁ of the first reflection surface 104 may be obtained in advance through simulation or actual measurement. A relational expression of the environmental parameters in the first reflection surface 104 and the reflectivity R₁ of the first reflection surface 104 is derived from the results using a fitting method such as a least-squares method, and the relational expression is stored in the storage unit included in the calculator 151. The calculator 151 is able to calculate the environmental parameters in the first reflection surface 104 from the reflectivity R₁ of the first reflection surface 104 based on the relational expression.

Alternatively, a set of environmental parameters with values known in advance and either of both of the light intensity P₁ of light radiated from the first reflection surface 104 and the light intensity P₂ of light radiated from the second reflection surface 105 may be measured in advance in any number of points. The calculator 151 is able to calculate the environmental parameters in the first reflection surface 104 to be obtained by comparing the measured light intensity and any number of measured sets for environmental parameters with unclear values. In this case, it is preferable that the storage unit that stores the set of the environmental parameter values and either or both of the light intensity P₁ and P₂ of light radiated from the light emitting device 102 is included in the calculator 151. The storage unit may be a commercially available hard disk, optical disc or solid state memory or the like. A relative variation amount may be detected rather than the absolute value of the environmental parameter.

Although a semiconductor laser element is used as the light emitting device 102 in the embodiment, another laser element, such as a fiber laser, may be used as the light emitting device 102 as long as the reflectivity of the first reflection surface 104 according to the variations in the optical properties around the reactant 120 or the reactant 120 itself, and further the oscillation conditions of the resonator vary.

### EXAMPLES

Next, several examples of the optical sensor system 200 of the embodiment will be described.

### Example 1

For Example 1, the reflectivity R₁ of the first reflection surface 104 before the reactant 120 is reacted (initial state) is 0.3 in the specific example described in FIGS. 2 to 4.

With reference to FIG. 4, in R₁=0.3, it is found that the above (5) establishes either of the light intensity P₁ of light radiated from the first reflection surface 104 and the light intensity P₂ of light radiated from the second reflection surface 105. That is, in the case of Example 1, even if either of the light intensity P₁ or the light intensity P₂ is detected, it is found that the sensitivity is higher than the optical sensor system of the related art described above.

In the embodiment, the reflectivity R₂ of the second reflection surface 105 becomes higher than the reflectivity R₁ of the first reflection surface 104 by becoming 0.7, the light in the light emitting device 102 is not easily transmitted to the outside, and the differential efficiency η₁ becomes higher than the differential efficiency η₂ as shown in FIG. 2, and the light intensity P₁ of light radiated from the first reflection surface 104 becomes larger than the light intensity P₂ of light radiated from the second reflection surface 105 as shown in FIG. 3.

With reference to FIG. 3, it is found that the light intensity P₂ of light radiated from the second reflection surface 105 increases along with an increase in the reflectivity R₁ of the first reflection surface 104, regardless of the value of the reflectivity R₁. Accordingly, if the reflectivity R₁ of the first reflection surface 104 is increased due to the reactant 120 reacting, the intensity detected by the first detector 103a increases as the reaction of the reactant 120 proceeds, and the S/N increases. In this case, because it is possible to set the light intensity detected by the detector 103a before reaction of the reactant 120 to a small value, it is possible to reduce the driving energy of the light emitting device 102, thereby reducing the amount of power consumed. Meanwhile, if the reflectivity R₁ of the first reflection surface 104 is decreased due to the reactant 120 reacting, the intensity detected by the first detector 103a decreases as the reaction of the reactant 120 proceeds. Thus, it is possible to perform circuit modulation so that the sensitivity of the detector 103a reaches the maximum in the state before reaction without saturating the detection intensity of the first detector 103a even if the reaction of the reactant 120 proceeds. Thus, in particular, it is possible to increase the S/N in a region with a minute variation amount, thus enabling highly sensitive detection.

According to FIG. 3, although the light intensity P₁ of light radiated from the first reflection surface 104 increases with the increase in the reflectivity R₁ of the first reflection surface 104, this turns to a slight decrease when the reflectivity R₁ of the first reflection surface 104 exceeds 0.45 (extremely large value). That is, when a range in which the reflectivity R₁ straddles 0.45 is made the detection range, because two reflectivities R₁ are present with respect to one light intensity P₁, if the reflectivity R₁ of the first reflection surface 104 increases due to the reactant 120 reacting, in a case where the reflectivity is detected only from the light intensity P₁ of light radiated from the first reflection surface 104, a range where the reflectivity R₁ of the first reflection surface 104 is 0.3 to 0.45 may be made the detection range. When the reflectivity R₁ of the first reflection surface 104 exceeds 0.31, because formula (5) is not established with respect to the light intensity P₁ of light radiated from the first reflection surface 104, the high sensitivity detection that is an effect of the present application is not obtained. Meanwhile, if the R₁ of the first reflection surface 104 is decreased due to the reactant 120 reacting, the intensity detected by the first detector 103a decreases as the reaction proceeds. Thus, it is possible to perform circuit modulation so that the sensitivity of the detector 103a reaches the maximum in the state before reaction without saturating the detection intensity of the first detector 103a due to reacting. Thus, in particular, it is possible to increase the S/N in a region with a minute variation amount, thus enabling highly sensitive detection.

### Example 2

For Example 2, the reflectivity R₁ of the first reflection surface 104 before the reactant 120 is reacted (initial state) is 0.7 in the specific example described in FIGS. 2 to 4.

With reference to FIG. 4, in Example 2, it is found that the above (5) establishes either of the light intensity P₁ of light radiated from the first reflection surface 104 and the light intensity P₂ of light radiated from the second reflection surface 105. That is, in the case of Example 2, even if either of the light intensity P₁ or the light intensity P₂ is detected, it is found that the sensitivity is higher than the optical sensor system of the related art described above.

With reference to FIG. 3, in a range were the reflectivity R₁ is 0.45 to 0.7, it is found that the light intensity P₁ of light radiated from the first reflection surface 104 is reduced slightly as the reflectivity R₁ of the first reflection surface 104 increases. Accordingly, if the reflectivity R₁ of the first reflection surface 104 is increased due to the reactant 120 reacting, the intensity detected by the second detector 103b decreases as the reaction of the reactant 120 proceeds. Thus, it is possible to perform circuit modulation so that the sensitivity of the second detector 103b reaches the maximum in the state before reaction without saturating the detection intensity of the first detector 103a even if the reaction of the reactant 120 proceeds. Accordingly, if the reflectivity R₁ of the first reflection surface 104 is decreased due to the reactant 120 reacting, as long as the reflectivity R₁ is 0.45 or more, the intensity detected by the second detector 103b increases as the reaction of the reactant 120 proceeds, and the S/N increases. In this case, because it is possible to set the light intensity detected by the detector 103b before reaction of the reactant 120 to a small value, it is possible to reduce the driving energy of the light emitting device 102, thereby reducing the amount of power consumed.

With reference to FIG. 3, regardless of the value of the reflectivity R₁, it is found that the light intensity P₂ of light radiated from the second reflection surface 105 increases as the reflectivity R₁ of the first reflection surface 104 increases. Accordingly, if the reflectivity R₁ of the first reflection surface 104 is increased due to the reactant 120 reacting, the intensity detected by the first detector 103a increases as the reaction of the reactant 120 proceeds, and the S/N increases. In this case, because it is possible to set the light intensity detected by the detector 103a before reaction of the reactant 120 to a small value, it is possible to reduce the driving energy of the light emitting device 102, thereby reducing the amount of power consumed. Meanwhile, if the reflectivity R₁ of the first reflection surface 104 is decreased due to the reactant 120 reacting, the intensity detected by the detector 103a decreases as the reaction of the reactant 120 proceeds. Thus, it is possible to perform circuit modulation so that the sensitivity of the first detector 103a reaches the maximum in the state before reaction without saturating the detection intensity of the first detector 103a even if the reaction of the reactant 120 proceeds. Thus, in particular, it is possible to increase the S/N in a region with a minute variation amount, thus enabling highly sensitive detection.

### Example 3

For Example 3, the reflectivity R₁ of the first reflection surface 104 before the reactant 120 is reacted (initial state) is 0.45 in the specific example described in FIGS. 2 to 4.

With reference to FIG. 4, in Example 3, it is found that the sensitivity dP₁/dR₁ is approximately 0 when the light intensity P₁ of light radiated from the first reflection surface 104 is detected, and the above formula (5) is not established. Meanwhile, when the light intensity P₂ of light radiated from the second reflection surface 105 is detected, the above (5) is established, and it is found that the sensitivity dP₂/dR₁ is higher than the optical sensor system of the related art described above. The result when the reflectivity R₁ of the first reflection surface 104 is increased or decreased due to the reaction of the reactant 120 is as described in Examples 1 and 2.

With reference to FIG. 3, it is found that the light intensity P₁ of light radiated from the first reflection surface 104 becomes the maximum value. Accordingly, if the reactant 120 has temperature dependency in which the reaction speed becomes higher as the temperature increases, it is possible to establish both high speed and high sensitivity by calculating sensitivity based on the light intensity P₂ while heating at the light intensity P₁. In a case where the reaction of the reactant 120 is reversible, for example, the reaction is reversed (refreshed) by light irradiation, because it is possible to refresh to maximum strength by calculating the sensitivity based on the light intensity P₁, it is possible to establish both high speed refreshing and high sensitivity.

### Example 4

For Example 4, the reflectivity R₁ of the first reflection surface 104 before the reactant 120 is reacted (initial state) is 0.1 in the specific example described in FIGS. 2 to 4.

With reference to FIG. 4, when R₁=0.1, the sensitivity dP₁/dR₁ is abnormally high when the light intensity P₁ of light radiated from the first reflection surface 104 is calculated. Because the sensitivity dP₁/dR₁ itself rapidly varies in approaching R₁=0.1, if the reflectivity dependence in the first reflection surface 104 of the sensitivity dP₁/dR₁ is rapid, the time until reaching a given light intensity is shortened. That is, the detection signal of the detector 103b rises sharply, and the detection speed of the optical sensor system 200 increases. Thus, it is possible to establish both high speed detection and high sensitivity. Alternatively, it is even possible to use one with a detection sensitivity lower by the amount that the detection signal of the detector 103b rises sharply as the detector 103b, and in so doing, it is possible for the range of the environmental parameters able to be detected to be widened.

### Example 5

In Example 5, operation is performed so that the light intensity P₁ of light radiated from the first reflection surface 104 becomes fixed without stipulating the reflectivity R₁ of the first reflection surface 104. At least either one of the light intensity P₁ of light radiated from the first reflection surface 104 and the light intensity P₂ of light radiated from the second reflection surface 105 is set so that the sensitivity becomes higher than the optical sensor system of the related art described above. In the example, feedback control is performed based on the light intensity information received by the driving circuit 108 that is the control means via the calculator 151 so that the light intensity P₁ of light radiated from the first reflection surface 104 is constant at a value stipulated by the user or the maker and either or both of the light intensity P₂ and the light intensity P₁ is detected using either or both of the detectors 103a and 103b. If the light emitting device 102 is a semiconductor laser element, the driving circuit 108 adjusts the injection current to the element. As shown in FIG. 3, in the light intensity P₁ of light radiated from the first reflection surface 104 and the light intensity P₂ of light radiated from the second reflection surface 105, because the dependency on the reflectivity R₁ of the first reflection surface 104 is different, in a case where the first detector 103a detects only the light intensity P₂ of light radiated from the second reflection surface 105, the driving circuit 108 performs feedback control so that the light intensity P₁ becomes constant based on the relationship between the light intensity P₁ and the light intensity P₂ stored in the storage unit included in the calculator 151 or the driving circuit 108. As a modification example, the driving circuit 108 may be directly connected to the two detectors 103a and 103b so as to be able to receive light intensity information without using the calculator 151.

The variation amount in either or both of the light intensity P₂ and the light intensity P₁ detected by the detectors 103a and 103b is recorded in the driving circuit 108 at a time interval at which feedback control is performed, and sequentially integrated. By doing so, because the total variation amount in either or both of the light intensity P₂ and the light intensity P₁ is found one the reactant 120 begins reacting, it is possible for the light intensity to be calculated in a case where feedback is not provided with a similar method as described above, and for the absolute value of the environmental parameters to be detected based thereupon.

In the example, because the light intensity P₁ at which the reactant 120 is irradiated becomes constant, the reaction temperature of the reactant 120 is substantially constant. If there is an action such that reaction of the reactant 120 increases the light intensity P₁ of light radiated from the first reflection surface 104, because control is performed such that the injection current to the light emitting device 102 is gradually reduced so that the light intensity P₁ is not increased, it is possible for the consumed power to be reduced.

### Example 6

In Example 6, either one of the light intensity P₁ of light radiated from the first reflection surface 104 and the light intensity P₂ of light radiated from the second reflection surface 105 is set so that the sensitivity becomes higher than the optical sensor system of the related art described above without stipulating the reflectivity R₁ of the first reflection surface 104.

In Example 6, the detector 103a detects the light intensity P₂ of light radiated from the second reflection surface 105, and the detector 103b detects the light intensity P₁ of light radiated from the first reflection surface 104. In so doing, if the reflectivity R₁ of the first reflection surface 104 increases due to the reactant 120 reacting, in a case where the reflectivity R₁ of the first reflection surface 104=0.65 (value of reflectivity R₁ at the intersection of dP₁/dR₁ and −P₁), as shown in FIG. 3, the light intensity P₁ of light radiated from the first reflection surface 104 is reduced as the reaction of the reactant 120 proceeds, and the light intensity P₂ of light radiated from the second reflection surface 105 increases. Accordingly, because the detection intensity with the detector 103b is lowered as the reaction of the reactant 120 progresses, it is possible to perform circuit modulation so that the sensitivity of the detector 103b becomes the maximum in the state before reaction without saturating the detection intensity of the second detector 103b due to reacting. Thus, in particular, it is possible to increase the S/N in a region with a minute variation amount, thus enabling highly sensitive detection. Meanwhile, the light intensity with the detector 103a increases as the reaction of the reactant 120 progresses, and the S/N increases. That is, in the example, it is possible for these two effects to be combined.

In a case where the reflectivity R₁ of the first reflection surface 104=0.3 (value of the reflectivity R₁ at the intersection of dP₁/dR₁ and P₁), it is preferable that at least one of the detectors 103a and 103b has high sensitivity and the other have low sensitivity as detectors. In so doing, possible for the detection speed as the optical sensor system 200 to be faster in the high sensitivity detector, and for the measurement range of the environmental parameters to be widened in the low sensitivity detector. That is, it is possible for a high sensitivity, high speed, wide range optical sensor system 200 to be obtained.

Above, although the reflectivity R₁ of the first reflection surface 104 was described by giving specific examples, as long as the effects described in each example are exhibited, the reflectivity R₁ may be other values. The values of the reflectivity R₂ of the second reflection surface 105 and the injection current may be modified, as appropriate.

### Embodiment 2

Next, the optical sensor head 1 according to Embodiment 2 of the invention in which the light blocking film 7 in which a through hole 8 is provided is a reactant 120 will be described with reference to FIGS. 5 to 8.

### [Configuration of Optical Sensor Head]

FIG. 5 is a perspective view of an optical sensor head 1 of the embodiment. The optical sensor head 1 is configured from a light emitting device 2, a light blocking film 7, a dielectric film 12, and a detector 3. Although not shown in the drawings, these are integrated by being packaged. The light emitting device 2 includes a first reflection surface 4, a second reflection surface 5 opposing the first reflection surface 4, and a waveguide 6 provided between the first reflection surface 4 and the second reflection surface 5. The light blocking film 7 is formed on the first reflection surface 4 with the dielectric film 12 interposed. A through hole 8 for generating near-field light is provided in the light blocking film 7. The hole axis of the through hole 8 is the extension axis of the waveguide 6.

The light emitting device 2 is configured provided with a first reflection surface 4 and a second reflection surface 5 on both ends of the waveguide 6, and light reciprocates in the waveguide 6 between the first reflection surface 4 and the second reflection surface 5. Gain is present in the waveguide 6, the light reciprocated by the waveguide 6 is energy amplified by the gain, and a portion of the light is radiated to the outside from the first reflection surface 4 and the second reflection surface 5. A commercially available laser element may be used as the light emitting device 2, and a semiconductor laser element is particularly preferable in order to achieve size reductions. In order to increase the sensitivity, a distributed feedback laser element may be used. By using the semiconductor laser element, as described later, calculating the refractive index inside the through hole 8 from the light intensity radiated to the outside through the second reflection surface 5 detected by the detector 3 becomes easy.

The first reflection surface 4, the second reflection surface 5 and the waveguide 6 are already provided in a commercially available laser element. However, it is possible for another film to be further formed on the first reflection surface 4 and the second reflection surface 5, thereby adjusting the reflectivity.

The light blocking film 7 is formed by a material that does not let peripheral light transmitted in order for near-field light to be generated in the through hole 8. In order to raise the sensitivity, in generating strong near-field light inside the through hole 8, it is preferable that the light blocking film 7 is formed from a metal that excites surface plasmons. Specifically, materials such as gold, silver, and aluminum are mainly used.

The through hole 8 formed in the light blocking film 7 generates near-field light with light radiated from the light emitting device 2. By filling the inside of the through hole 8 with the detection target, variations in the refractive index inside the through hole 8 arise. Both a case where the detection target is independently arranged inside the through hole 8 and a case where the detection target is arranged inside the through hole 8 in a state of being included in a gas (for example, air) or a liquid (for example, water) are possible.

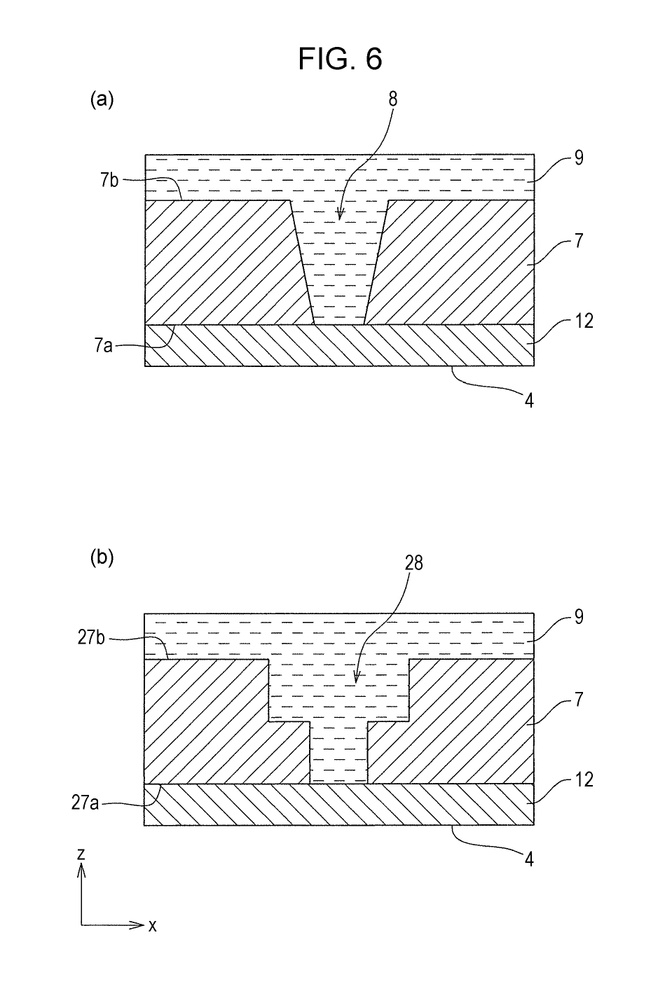

In the through hole 8, the area of the emission surface 7b of light in the light blocking film 7 is larger than the opening area on the opposing surface 7a of the light blocking film 7 opposing the first reflection surface 4. FIG. 6(a) shows the specific configuration. FIG. 6(a) is a cross-sectional view showing the cross-section of the light blocking film 7 along the line xz that includes the dashed line in FIG. 5. In FIG. 6(a), the increase rate of the cross-sectional area (xy cross-sectional area) of the through hole 8 is continuous from the opposing surface 7a that contacts the dielectric film 12 on the first reflection surface 4 to the emission surface 7b of light. In the example depicted in FIG. 6(a), the two surfaces opposing in the x direction from the hole surfaces that define the through hole 8 are tapered surfaces in which the incline with respect to the opposing surface 7a is constant, and the two surfaces are inclined with respect to the z axis so that the xy cross-sectional area of the through hole 8 increases upwards, and the increase amount is constant.

Meanwhile, in another example depicted in FIG. 6(b) that is a cross-sectional view showing the same xz cross-section, a step-like through hole 28 is formed in the light blocking film 7. In this example, the increase rate of the cross-sectional area (xy cross-sectional area) of the through hole 28 is discontinuous from the opposing surface 27a that contacts the dielectric film 12 on the first reflection surface 4 to the emission surface 27b of light. In the example depicted in FIG. 6(b), the two surfaces opposing in the x direction from the hole surfaces that define the through hole 28 have a step like shape that includes one horizontal portion, and a two vertical parts (an upward vertical part and a downward vertical part) are formed on the two surfaces with the horizontal part interposed so that the xy cross-section area of the through hole 28 is larger upward than downward with the horizontal part as a boundary. The increase rate of the cross-sectional area of the through hole 28 is discontinuous at the boundary of the horizontal and vertical parts. In FIGS. 6(a) and 6(b), a condition where the detection target 9, which is a liquid, is filled in the trough holes 8 and 28 is depicted as an example.

The shape and size of the through holes 8 and 28 strongly influences the intensity distribution of the near-field light in the through holes 8 and 28. Specifically, near-field light tends to be more strongly excited the shorter the inter-surface distance between the two surfaces that face each other is. In the embodiment, by the shape of the through holes 8 and 28 varying in at least the xz cross-section as shown in FIGS. 6(a) and 6(b), the opening area of the through holes 8 and 28 on the emission surfaces 7b and 27b is larger than the opening area of the through holes 8 and 28 in the opposing surfaces 7a and 27a. Thereby, regardless of the direction of any of linearly polarized light, circularly polarized light and elliptically polarized light emitted from the light emitting device 2 and the polarized light, it is possible to strengthen the intensity of the near-field light generated in the through hole 8 and 28 more in the vicinity of the opposing surfaces 7a and 27a than in the vicinity of the emission surfaces 7b and 27b. The shape of the through holes 8 and 28 may vary in both the xz cross-section and the yz cross-section.

As a result, because near-field light generated in the through holes 8 and 28 is concentrated in the vicinity of the opposing surfaces 7a and 27a of the light blocking film 7, there is almost no influence due to the refractive index of the distance from the through holes 8 and 28 per refractive index measurement inside the through holes 8 and 28. Thus, in the vicinity of the through holes 8 and 28, it is possible to mainly detect the refractive index inside the through holes 8 and 28 with good sensitivity. Therefore, detection on the molecular level is possible if the opening area in the opposing surfaces 7a and 27a of the through holes 8 and 28 is made sufficiently small. Since the detection target may be present only inside the through holes 8 and 28, it is possible to reduce the sample volume. Further, size reductions are possible because a separate light source is made unnecessary.

The cross-sectional shape of the through hole 8, as shown in FIG. 6(a), may be curved (cup shaped) rather than linear (trapezoid). As long as the increase rate in the cross-sectional area of the through hole is continuous, the incline angle may vary partway along. As long as the increase amount in the cross-sectional area of the through hole is discontinuous, the cross-sectional shape of the through hole 28 may vary in three or more steps rather than vary in two stages as shown in FIG. 6(b), or may not include either or both of the horizontal part or the vertical part. Alternatively, the through holes 8 and 28 may be asymmetrical on the z axis rather than symmetrical (FIGS. 6(a) and 6(b)). For example, a single side in FIGS. 6(a) and 6(b) may be a parallel surface to the z axis.

According to the example in FIG. 6(a), the detection target does not easily collect at the periphery of the emission surface 7b of light, and smoothly enters until the vicinity of the opposing surface 7a with a strong intensity distribution of light. Therefore, even if the area in the opposing surface 7a is small, it is possible to perform detection with sufficient sensitivity. According to the example in FIG. 6(b), it is possible to widen the range in which the intensity distribution of light inside the through hole 28 is strong, and it is possible to increase the detection sensitivity.

If the light emitted from the light emitting device 2 is x polarized light or y polarized light, the shape of the through hole may vary in either or both of the xz cross-section and the yz cross-section so that the opening area of the through hole on the emission surface becomes larger than the opening area of the through hole on the opposing surface. If the light emitted from the light emitting device 2 includes both x polarized light and y polarized light, the shape of the through hole may vary in either of the xz cross-section or the yz cross-section so that the opening area of the through hole on the emission surface becomes larger than the opening area of the through hole on the opposing surface. In this case, it is preferable that the shape of the through hole varies in both of the xz cross-section and the yz cross-section.

The surface plasmons have the characteristics of being strongly excited in the surface orthogonal to the polarization direction of incident light. Accordingly, in the embodiment, if the light emitted from the light emitting device 2 is x polarized light, by the shape of the through holes 8 and 28 varying in at least the xz cross-section, the opening length of the through holes 8 and 28 relating to the x direction on the emission surfaces 7b and 27b becomes larger than the opening area of the through holes 8 and 28 relating to the x direction on the opposing surfaces 7a and 27a. Thereby, it is possible to further strengthen the intensity of near-field light generated in the through holes 8 and 28 in the vicinity of the opposing surfaces 7a and 27a over that in the vicinity of the emission surfaces 7b and 27b. Accordingly, it is possible for the detection sensitivity to be still further increased.

The opening length of the through holes 8 and 28 relating to either of the x direction or the y direction on the opposing surfaces 7a and 27a becomes shorter than the wavelength of light emitted from the light emitting device 2. Thereby, almost no light is transmitted through the through holes 8 and 28, there is little influence from the outside of the through holes 8 and 28, and it is possible to detect only the refractive index inside the through holes 8 and 28.

In the optical sensor head 1 of the embodiment, the smaller the opening size of the through holes 8 and 28, the smaller the size of the detection target entering inside through holes 8 and 28. By the opening size of the through holes 8 and 28 being approximately several nm, it is possible for only one molecule of the detection to enter the through holes 8 and 28. That is, it is possible for the through holes 8 and 28 to have the function of separating detection targets of a given size or less. Even if the optimal through hole in which the intensity of near-field light generated is strengthened has a shape with an abnormally narrow width, if the shape is a discontinuous shape as shown in FIG. 6(b), it is possible for the detection target entering inside the through hole 28 to be separated by the opening size of the through hole 28 in the emission surface 27b of light.

The detector 3 may be a commercially available photodetector or may be a spectroscope. Although the commercially available photodetector only detects intensity, the costs are lower at a small size. Meanwhile, although a spectroscope does not have a similarly small size, because it is possible for a reflection spectrum to be detected, it is possible to obtain not only the intensity, but also information on wavelength shifts. The detector 3 may be arranged on the opposite side to the light emitting device 2 with the light blocking film 7 interposed in addition to or instead of the detector 3. In this case, the detector 3 detects the intensity of light transmitted through the first reflection surface 4 and the through hole 8. Light transmitted through the through hole 8 mainly refers to light in which near-field light generated in the through holes 8 and 28 is scattered. Because the near-field light generated in the through holes 8 and 28 is strengthened in the vicinity of the opposing surfaces 7a and 27a over that in the vicinity of the emission surfaces 7b and 27b, the intensity of light in which near-field light in the vicinity of the opposing surfaces 7a and 27a is scattered is strengthened. Thereby, even in a case of detecting light transmitted through the through hole 8, there is little influence from the outside of the through holes 8 and 28, and it is possible to detect only the refractive index inside the through holes 8 and 28.

### [Operation of Optical Sensor Head]

When the refractive index inside the through holes 8 and 28 varies, the reflectivity of the first reflection surface 4 (below, although description is made assuming that the dielectric film 12 is not provided, the similar description as below is also established in cases where the dielectric film 12 is provided) varies, and the intensity distribution of light in the waveguide 6 that reciprocates between the first reflection surface 4 and the second reflection surface 5 varies. Therefore, the transmissivity of light emitted from the second reflection surface 5 is varied. Thus, the refractive index inside the through holes 8 and 28 is found by detecting the transmissivity of light emitted from the second reflection surface 5. For example, if an adsorption layer that adsorbs a specified molecule is provided inside the through holes 8 and 28, the concentration of a specified molecule is found.

Below, the specific configuration will be described using a finite difference time domain (FDTD) simulation and the logically calculated results.

First, the intensity distribution of light is obtained with the FDTD simulation for the next three structures (1), (2), and (3).

In the structure (1), the light blocking film 7 is gold with a film thickness of 135 nm, the through hole 8 has a width in the xz direction on the first reflection surface 4 of 50 nm, and a width in the xz direction on the emission surface of the light of 200 nm, and the cross-section is a trapezoidal slit as in FIG. 6(a) that continues to infinity in the y direction. The inside is air (refractive index=1.0).

In the structure (2), the light blocking film 7 is gold with a film thickness of 135 nm, the through hole 8 has a width of 50 nm in the xz direction with a film thickness of up to 70 nm from the first reflection surface 4, and a width of 200 nm in the xz direction up to the emission surface of the light from a film thickness of 70 nm, and the cross-section is a two-stage slit as in FIG. 6(b) that continues to infinity in the y direction. The inside is air (refractive index=1.0).

In the structure (3), the light blocking film 7 is gold with a film thickness of 135 nm, and the through hole 8 is a slit with a width in the xz direction of 50 nm that continues to infinity in the y direction. The inside is air (refractive index=1.0).

Although any of the structures continue to infinity in the y direction, this corresponds to a state in which the through hole 8 is formed sufficiently long in the y direction with respect to the waveguide 6 of the light emitting device 2.

The incident light is any polarized light in the width direction (x direction) of the slit, and has a wavelength of 780 nm.

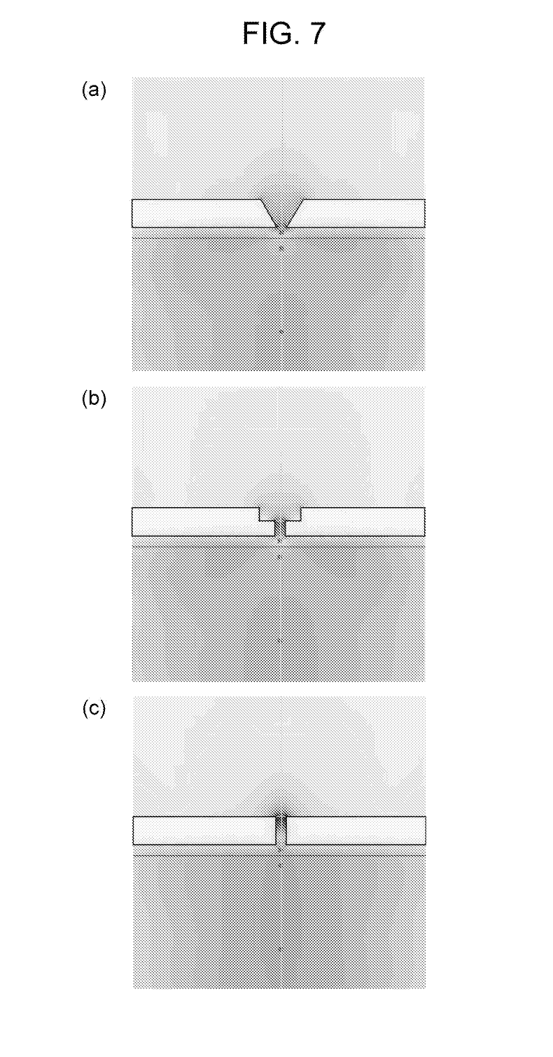

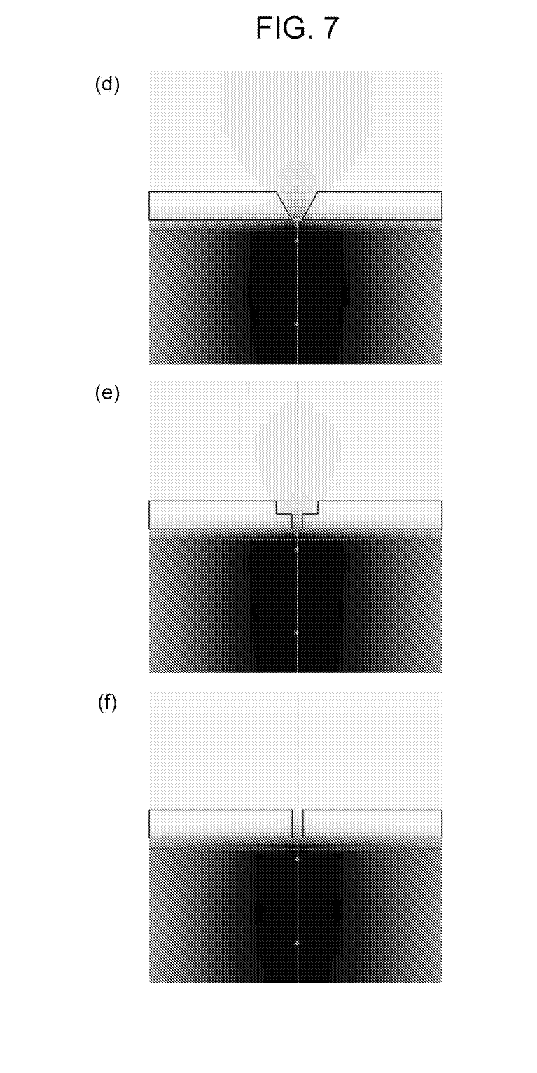

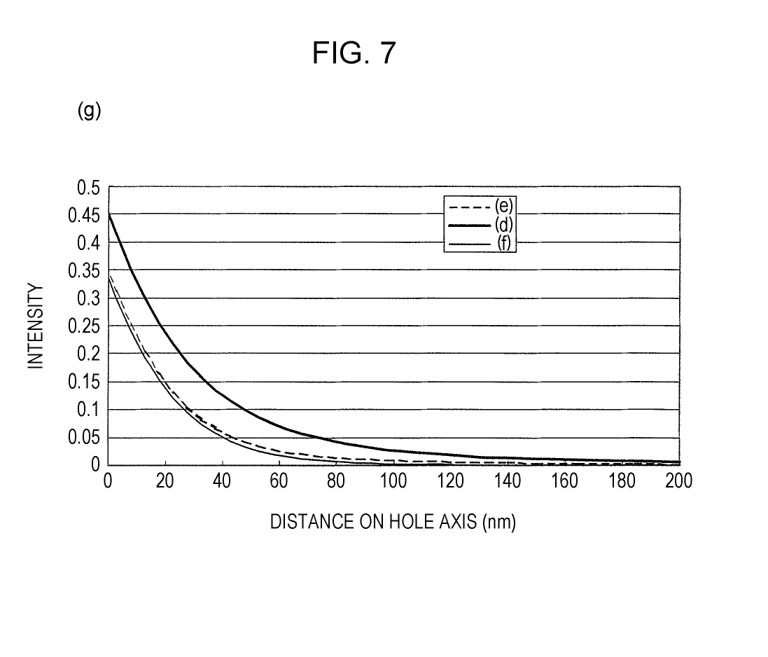

FIGS. 7(a), 7(b), and 7(c) show the simulation results (all intensity scales are the same) of the intensity distribution of light on the cross-section that includes the polarization direction with respect to each of the structures (1), (2), and (3). If the through hole is the simple slit shape (structure (3)) of the related art, as shown in FIG. 7(c), the intensity increases to its highest at the edge of the through hole in the emission surface of light. Therefore, strong light is also distributed to the outside by the emission surface of the light. Meanwhile, in the structure (1), the intensity is highest at the edge of the through hole 8 in the opposing surface 7a, and in the structure (2), the highest intensity is from the opposing surface 27a to where the slit width changes. That is, in the structures (1) and (2), it is possible for the intensity distribution of light to be drawn to the inside by the emission surfaces 7b and 27b, and is a structure sensitive to refractive index variations inside the through holes 8 and 28.

With respect to the structure (1), the structure (2) has a wider range in which the light intensity inside the through hole is strong and is better able to increase the detection sensitivity. However, the structure (1) is less easily influenced from the outside of the through hole. The structure (1) less easily accumulates the detection target in the vicinity of the emission surface 7b of light, and the detection target more smoothly enters until the vicinity of the opposing surface 7a in which the light intensity is strong.

In the configuration, FIGS. 7(d), 7(e), and 7(f) show the results of a case in which the polarization direction of the incident light is a direction (y direction) orthogonal to the width of the slit. FIGS. 7(d), 7(e), and 7(f) are the simulation results of the intensity distribution of light on the cross-section that includes the width direction of the slit, with respect to each of the structures (1), (2), and (3). However, the intensity scales thereof are one-third those in FIGS. 7(a), 7(b), and 7(c). If the through hole is the simple slit shape (structure (3)) of the related art, as shown in FIG. 7(f), although only a little light leaks out to the periphery of the through hole 8 in the opposing surface 7a, in the structures (1) and (2), the leakage amount increases, and it is possible for intensity distribution of light on the inside to be increased due to the emission surfaces 7b and 27b of light. FIG. 7(g) shows, for each of the configurations, the intensity distribution from the opposing surfaces 7a and 27a toward the emission surfaces 7b and 27b on the hole axis. It is found from the graph that the light intensity inside the through holes of the structures (1) and (2) is stronger than in the structure (3), and the intensity in the emission surfaces 7b and 27b is sufficiently low. That is, the structures (1) and (2) become structures sensitive to refractive index variations inside the through holes 8 and 28.

Next, the influence that variations in the reflectivity of the first reflection surface 4 exert on the oscillation conditions of the semiconductor laser element that is the light emitting device 2 is calculated. The oscillation conditions of the semiconductor laser element are the threshold current and the differential efficiency. It is known that these are generally represented with the following equations (1) to (3).

$$\begin{matrix}[ Math . 2 ] & \\ {η}_{1} = {η}_{stm} \frac{{T}_{1}}{2 - {R}_{1} - {R}_{2}} \frac{\frac{1}{2 L} ln \frac{1}{{R}_{1} {R}_{2}}}{{α}_{int} + \frac{1}{2 L} ln \frac{1}{{R}_{1} {R}_{2}}} \frac{hv}{q} & ( 1 ) \\ [ Math . 3 ] & \\ {η}_{2} = {η}_{stm} \frac{{T}_{2}}{2 - {R}_{1} - {R}_{2}} \frac{\frac{1}{2 L} ln \frac{1}{{R}_{1} {R}_{2}}}{{α}_{int} + \frac{1}{2 L} ln \frac{1}{{R}_{1} {R}_{2}}} \frac{hv}{q} & ( 2 ) \\ [ Math . 4 ] & \\ Ith = LW \cdot \frac{d}{{η}_{i} Γ} ( {α}_{i} + \frac{1}{2 L} ln \frac{1}{{R}_{1} {R}_{2}} ) + {J}_{0} \frac{d}{{η}_{i}} & ( 3 )\end{matrix}$$

Each parameter is as follows.

η₁: differential efficiency of light radiated from first reflection surface 4
η₂: differential efficiency of light radiated from second reflection surface 5
Ith: threshold current
R₁: reflectivity of first reflection surface 4
R₂: reflectivity of second reflection surface 5
T₁: transmissivity of first reflection surface 4
T₂: transmissivity of second reflection surface 5
ηₛₜₘ: differential efficiency of inside
ηᵢ: quantum efficiency of inside
αᵢₙₜ: internal loss
J₀: transparency current
Π: optical confinement coefficient of active layer
h: Planck constant
v: frequency of light
q: load of electron
L: resonator length
W: width of active layer
d: thickness of active layer

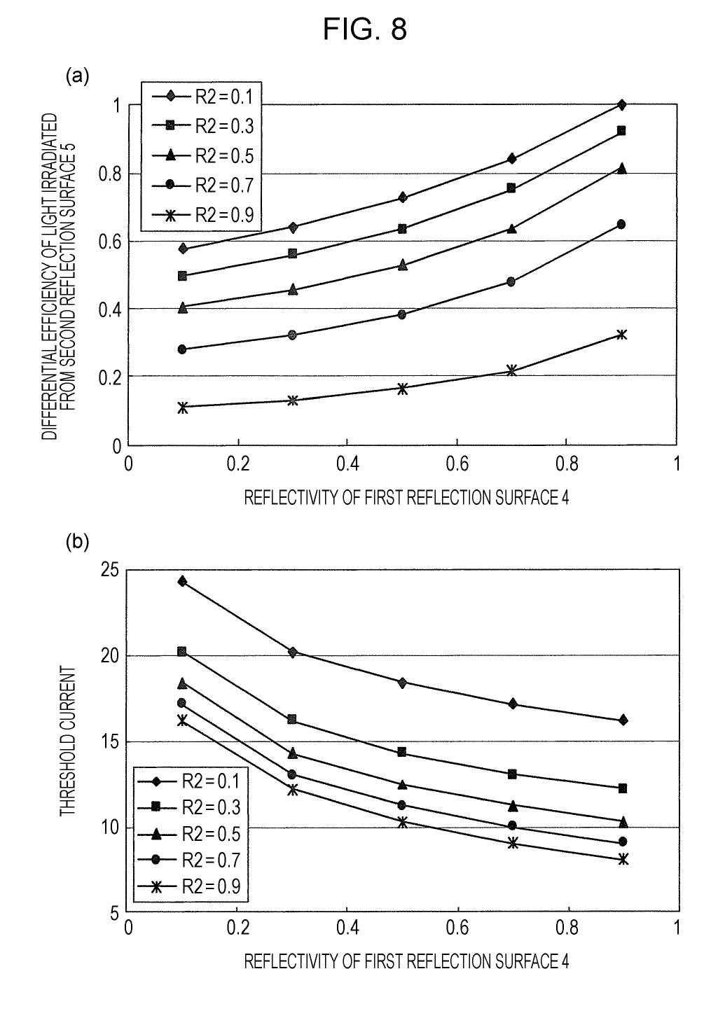

FIG. 8 shows (a) the differential efficiency (η₂) of light radiated from the second reflection surface 5 and (b) variations in the threshold current, respectively, when the reflectivity (R₁) of the first reflection surface 4 and the reflectivity (R₂) of the second reflection surface 5 are varied using the parameters of a semiconductor laser element with a representative wavelength of 780 nm.

It is found in FIG. 8(a) that the differential efficiency (η₂) of light radiated from the second reflection surface 5 varies according to the varying of the reflectivity (R₁) of the first reflection surface 4. It is found that the greater the reflectivity (R₁) of the first reflection surface 4, the more the variation amount of the differential efficiency (η₂) of light radiated from the second reflection surface 5 increases with respect to variations in the reflectivity (R₁) of the first reflection surface 4. It is found that the lower the reflectivity (R₂) of the second reflection surface 5, the more the variation amount of the differential efficiency (η₂) of light radiated from the second reflection surface 5 increases with respect to variations in the reflectivity (R₁) of the first reflection surface 4.

Thus, in detecting the refractive index from variations in the differential efficiency (η₂) of light radiated from the second reflection surface 5, it is preferable that the reflectivity (R₁) of the first reflection surface 4 is larger, and the reflectivity (R₂) of the second reflection surface 5 is smaller.

Meanwhile, from FIG. 8(b), it is found that the threshold current varies according to the varying of the reflectivity (R₁) of the first reflection surface 4. It is found that the lower the reflectivity (R₁) of the first reflection surface 4, the greater the variation amount of the threshold current with respect to variations in the reflectivity (R₁) of the first reflection surface 4. However, it is found that the even if the reflectivity (R₂) of the second reflection surface 5 varies, the variation amount of the threshold current with respect to variations in the reflectivity (R₁) of the first reflection surface 4 does not substantially vary. That is, although the lower the reflectivity (R₂) of the second reflection surface 5, the greater the value of the threshold current is, the entire curve is substantially the same, and there is almost no variation in the variation amount of the threshold current.

Thus, in detecting the refractive index from variations in the threshold current, it is preferable that the reflectivity (R₁) of the first reflection surface 4 is smaller. However, the reflectivity (R₁) of the first reflection surface 4 being low signifies that the light amount radiated from the first reflection surface 4 becoming stronger or the light amount absorbed by the first reflection surface 4 increasing, and in either care, heat is contributed to the detection target 9 present in the vicinity of the first reflection surface 4. Therefore, it is preferable that the temperature variations are corrected by the heating amount.

### [Method of Manufacturing of Optical Sensor Head]

Next, the manufacturing method of the optical sensor head 1 shown in FIG. 6(a) will be described. The light emitting device 2 may use a commercially available laser element, and a flight blocking film 7 may be formed on the first reflection surface 4 via the dielectric film 12, and thereafter a through hole 8 may be formed in the light blocking film 7. A commercially available photodetector may be arranged as the detector 3 so as to be able to detect the light intensity of light emitted to the outside through the second reflection surface 5.

For example, in a case where a semiconductor laser element is used as the light emitting device 2, it is possible to use a type in which the semiconductor laser element, and a detector 3 that monitors the light emission intensity from the rear surface of the semiconductor laser element are packaged. The light blocking film 7 (such as gold, silver or aluminum) may be formed on the emission surface (first reflection surface 4) of the semiconductor laser element by sputtering, deposition or the like with the dielectric film 12 interposed so that the p electrode and the n electrode are not electrically connected, and thereafter the through hole 8 may be formed by a focused ion beam (FIB), photolithography, or the like.

In making the shape of the through hole 8 have a larger opening area on the emission surface 7b of light than the opening area on the opposing surface 7a, the scanning method of the condensed FIB beam and the photolithography conditions may be determined, as appropriate. For example, in creating the structure such as in FIG. 6(a), the number of scans with the FIB to the outside in the x direction may be reduced and the number of scans to the center may be increased. A mask is arranged in advance in the region of the through hole 8, and, by forming a film from an incline, a light blocking portion may be formed and thereafter the mask of the through hole 8 may be removed. In creating the structure as in FIG. 6(b), after a wide concavity is engraved in the emission surface 27b of light, a narrow through hole may be engraved between the bottom surface of the concavity and the opposing surface 27a.

Although sensing is possible with only the above-described structure in a case of using the light emitting device 2 in a gas, in a case of performing more precise measurement or a case of using a liquid, skill is necessary. In particular, in a case where the light emitting device 2 is a semiconductor laser element, because the p electrode and the n electrode are electrically connected when the optical sensor head 1 comes in contact with the liquid as is, light is not emitted and, in the worst case, the head breaks down.

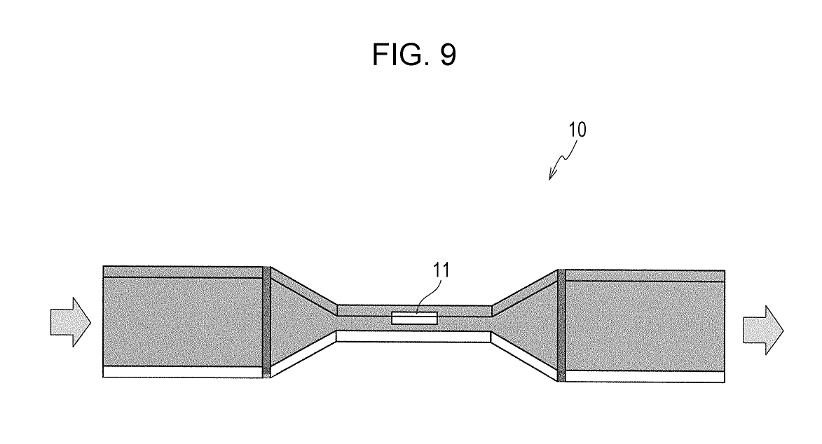

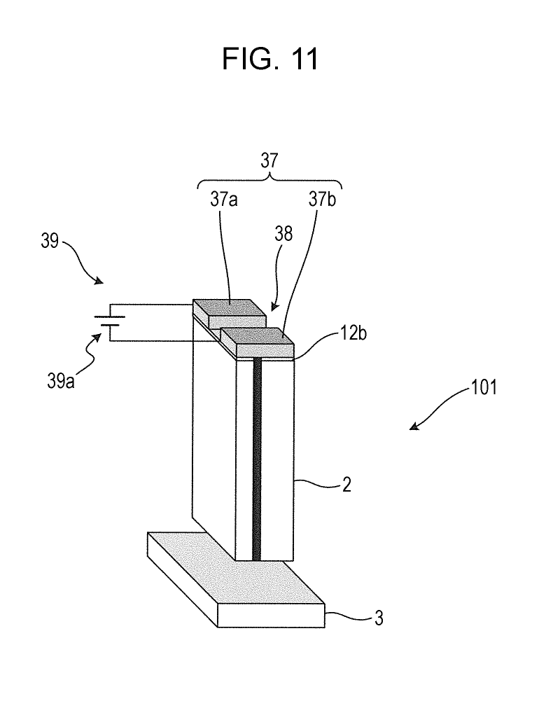

In order to prevent this, it is preferable to use a flow channel member so that the either or both of the gas and the liquid that includes the detection target 9 flows only to the vicinity of the through hole 8. FIG. 9 is a perspective view of an example of a flow channel member 10. In FIG. 9, a window (opening portion) 11 through which the flow channel is exposed to the outside is provided in the center portion of the upper surface of the flow channel member 10 in which a flow channel is formed from left to right in the drawing on the inside thereof. The window 11 is preferably formed in the emission surface 7b at the opening size of the through hole 8 or greater. The flow channel member 10 is adhered to the light blocking film 7 (refer to FIG. 11) so that the through hole 8 of the light blocking film 7 is within the range of the window 11 (preferably matching the opening in the emission surface 7b). For example, by interposing a rubber ring so as to surround the opening and the window 11 in the emission surface 7b of the through hole 8 between the light blocking film 7 and the flow channel member 10, it is possible for the gas or liquid that includes the detection target 9 to flow without leaking. In the example shown in FIG. 9, although the width of the flow channel member 10 narrows at the periphery of the window 11, the width of the flow channel member 10 may be uniform. An end of the flow channel member 10 is connected to a tube so that the liquid including the detection target 9 is suctioned from the flow channel member 10. Although the window 11 may be smaller than the opening size of the through hole 8 in the emission surface 7b, there is concern of either or both of the air and the liquid that includes the detection target 9 accumulating in the range of the through hole 8 that is larger than the window 11 according to the flow rate of either or both of the gas and the liquid that includes the detection target 9.

### [Modification Example Relating to Dielectric Film]

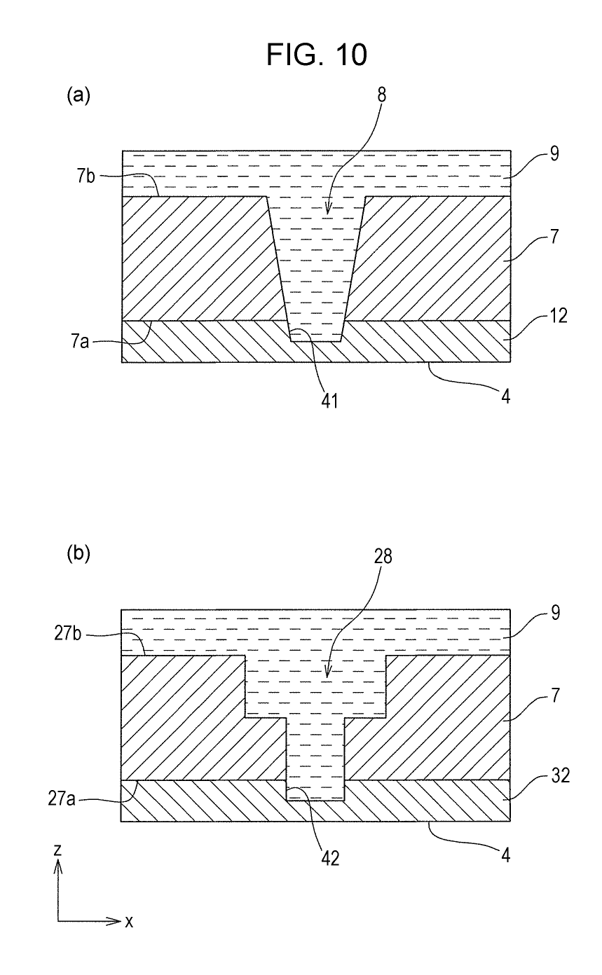

A modification of the above-described embodiment will be described. In the example shown in FIG. 10(a), a concavity 41 connected to the through hole 8 is formed in the dielectric film 22 formed on the first reflection surface 4. The concavity 41 is defined by the tapered surface that forms an inclined surface, has the same inclination angle as the tapered surface described above that defines the through hole 8, and is connected thereto. One concavity is formed by forming a single through hole 8 and concavity 41. At this time, since the x direction size of the through hole 8 is smallest at the bottom surface of the concavity 41, the light intensity becomes strongest. If the concavity 41 connected to the through hole 8 is formed in the dielectric film 22 in this way, because it is possible for the detection target 9 to be present in the concavity 41, it is possible to further raise the sensitivity.

In the example shown in FIG. 10(b), a concavity 42 connected to the through hole 28 is formed in the dielectric film 32 formed on the first reflection surface 4. The concavity 42 is defined by two vertical surfaces separated by the same width as between lower vertical part that is lower than the horizontal part of the through hole 28. One concavity is formed by forming a single through hole 28 and concavity 42. At this time, since the x direction size of the through hole 28 is smallest between the horizontal part and the bottom surface of the concavity 42, the light intensity becomes strongest. If the concavity 42 connected to the through hole 28 is formed in the dielectric film 32 in this way, because it is possible for the detection target 9 to be present in the concavity 42, it is possible to further raise the sensitivity.

### [Modification Example Relating to Electrophoresis]

As another modification example, in the optical sensor head 101 shown in FIG. 11, a light blocking film 37 that is divided into two regions 37a and 37b insulated from one another with the through hole 38 as a boundary is used. In this modification example, although the through hole 38 is formed as a slit that divides the light blocking film 37 in two, the through hole is not necessarily limited to such a form, the light blocking film may be divided in two regions insulated from one another by the through hole and an insulating layer.

A circuit 39 including a direct current power source 39a is provided as voltage application means for applying a direct current voltage between the two regions 37a and 37b of the light blocking film 37. By applying a voltage between the regions 37a and the 37b using the circuit 39, it is possible to collect the detection target inside the through hole 38 through electrophoresis. The reason for this is that when a voltage is applied between the two regions 37a and 37b insulated from one another, a strong electric field arises in the location at which the gap between the two regions 37a and 37b is narrowest. In the embodiment, because the detection target is collected, the detection sensitivity is further improved. An alternating current is applied between the two regions 37a and 37b, and the size or the like of the detection target able to be collected may be selected according to the frequency thereof.

### Embodiment 3

### Configuration of Optical Sensor System

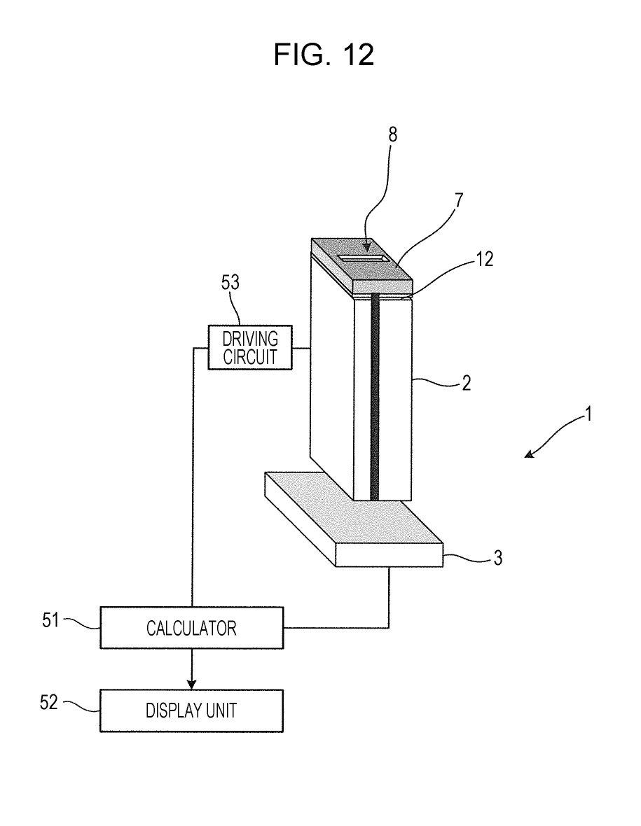

The optical sensor system according to Embodiment 3 of the invention will be described with reference to FIG. 12. The optical sensor system shown in FIG. 12 includes the optical sensor head 1 shown in detail in FIG. 5, a calculator 51 that analyzes the results detected by the detector 3 of the optical sensor head 1 and calculates the refractive index in the through hole 8, a display unit 52 that displays the calculation results of the calculator 51, and a driving circuit 53.

The calculator 51 may be only a circuit system, or may be a computer and software that operates on the computer.

The display unit 52 may use a commercially available display, or may display only the numerals (refractive index) of the environmental parameters. In a case of using a computer as the calculator 51, if a computer-compliant display is used as the display unit 52, it is possible for the refractive index to be displayed as a graph on the display. In a case of using a computer as the calculator 51, it is possible for a user to input the measurement conditions or the analysis content using an input device such as a keyboard.

The driving circuit 53 is a circuit for driving the light emitting device 2 of the optical sensor head 1, is connected to two electrodes, not shown, of the light emitting device 2, and supplies an injection current to the light emitting device 2 via the two electrodes. Because there are cases where the driving conditions of the light emitting device 2 are also necessary in the analysis in the calculator 51, the calculator 51 is connected to a driving circuit 53 of the light emitting device 2 as shown in FIG. 12.

The program provided with an algorithm relating to the operation of the optical sensor system, described later, may be provided by the manufacturer, or may be created by the user themselves.

### [Operation of Optical Sensor System]

For the analysis of the detection results performed by the calculator 51 and the calculation of the refractive index, a case in which the light emitting device 2 is a semiconductor laser element and the detection result is the light intensity of light radiated from the second reflection surface 5 will be described.

First, in calculating the differential efficiency (η₂) of light radiated from the second reflection surface 5, a current flows with at least two current values of the threshold current or higher with respect to the light emitting device 2, and the light intensity of light radiated from the second reflection surface 5 at this time is detected by the detector 3. The calculator 51 obtains the differential efficiency (η₂) by dividing the difference between the plurality of detection intensities detected by the detector 3 by the difference in current values. It is known that the light emission intensity P of the semiconductor laser element, when the injection current I is the threshold current or higher, is represented by the linear relation expression such as

[Math. 6]

P=η₂(I−Ith) (6)

Thus, the measured current value may be at least two points. If the number of measurement points in increased and fitting is performed, it is possible to reduce the influence of measurement errors.

In a case where the detector 3 has a configuration that detects only a portion of the light radiated from the second reflection surface 5, the calculation of the refractive index may be corrected by comparing the total light amount of light radiated from the second reflection surface 5 and the detected light amount. In this case, the storage unit included in the calculator 51 may store the correction coefficient.

Also in a case where the calculator 51 calculates the threshold current, the current flows with at least two current values of the threshold current or higher, and the light intensity of light radiated from the second reflection surface 5 at this time is detected by the detector 3. After the differential efficiency (η₂) of light radiated from the second reflection surface 5 is calculated by the calculator 51, the threshold current is obtained by entering the calculated differential efficiency η₂ in the expression (6).

Next, the method of obtaining the refractive index from either or both of the threshold current and the differential efficiency will be described. If either or both of the expressions (2) and (3) is used in calculating the reflectivity of the first reflection surface 4 from either or both of the threshold current and the differential efficiency, unique calculation is possible.

In calculating the refractive index inside the through hole 8 from the calculated reflectivity of the first reflection surface 4, the relationship between the refractive index inside the through hole 8 and the reflectivity of the first reflection surface 4 is obtained at several points in advance through FDTD simulation or actual measurement, and the results are stored in the storage unit included in the calculator 51. If the relational expression between the refractive index inside the through hole 8 and the reflectivity of the first reflection surface 4 is obtained from the results using a fitting method such as a least-squares method, it is possible to calculate the refractive index inside the through hole 8 from the reflectivity of the first reflection surface 4.

Alternatively, as long as an adsorption layer that adsorbs the specified molecule is provided inside the through hole 8 and the concentration of the specified molecule is detected, a sample with an unknown concentration may be measured after measuring a sample with a known concentration before measurement and recording either or both of the threshold current and the differential efficiency at this time. In this case, a storage unit that stores the results in which a sample with a known concentration are recorded before measurement may be provided in the calculator 51. The storage unit may be a commercially available hard disk, optical disc or solid state memory or the like.

### [Example Using Spectroscope as Detector]

It is known that the oscillation wavelength of the semiconductor laser element varies according to the environmental temperature. According to this principle, if a spectroscope or the like is used as the detector 3, and not only the intensity, but also spectrum measurement is performed, it is possible to correct variations in the threshold current and differential efficiency according to variations in the environmental temperature. It is possible for the refractive index to also be corrected according to the temperature of the detection target and the light blocking film. Specifically, the calculator 51 may hold the results in which the relationship between the temperature and the oscillation wavelength is measured in advance, or may calculate the results from the configuration of the semiconductor laser element.

### [Example Using Plurality of Optical Sensor Heads]

A plurality of optical sensor heads 1 may be used in the optical sensor system of the invention. For example, if the shapes of the through holes 8, materials of the light blocking films 7, the wavelengths of the light emitting devices 2, and the like are different from one another, the information obtained from the respective optical sensor heads 1 is different. By integrating these pieces of information, it is possible for the effects of more accurately detecting the detection target 9, widening the concentration range in which the detection target 9 is detected, increasing the types of detection target 9 and the like to be obtained. In this case, the optical sensor heads 1 may be arranged spaced apart from one another, may be arranged in rows in close proximity, and may be selected according to the object.

If a plurality of optical sensor heads 1 having the same configuration is arranged in rows along the flow channel 10, the information obtained from the plurality of optical sensor heads 1 is integrated, and it is possible for information on the time variations of the detection target 9 or the location dependency to be obtained. If the concentration of the detection target 9 or the flow rate of the detection target 9 is changed, and the time variations or location dependency is measured, it is possible for the dynamic characteristics (such as viscosity and dispersity) of the detection target 9 in the flow channel to be known. If adsorption layer that adsorbs the specified molecule is provided inside the through hole 8 and the concentration of the specified molecule is detected, it is possible for the reaction conditions (such as reaction speed and dissociation constant) with respect to the adsorption layer to be known.

The optical sensor system according to the above-described Embodiment 1 includes a light emitting device that includes a first reflection surface, a second reflection surface that opposes the first reflection surface and a waveguide provided between the first reflection surface and the second reflection surface; a reactant formed on the first reflection surface; a first detector that detects a light intensity of light emitted from one of the first reflection surface and the second reflection surface; and a calculator that calculates environmental parameters in the first reflection surface based on the light intensity detected by the first detector, in which the reflectivity R₁ of the first reflection surface and the light intensity P(R₁) detected by the detector satisfy the following relationship.

$$\vert \frac{d P ( {R}_{1} )}{d {R}_{1}} \vert > P ( {R}_{1} ) \qquad [ Math . 1 ]$$

With the above configuration, an optical sensor system with a higher sensitivity than the optical sensor system of the related art described above is obtained. Because the reactant is formed on the first reflection surface of the light emitting device, optical adjustment is unnecessary and variations over time, such as position shifting, do not occur. Thus, costs are reduced by the amount that the manufacturing steps are reduced and the positional shifting countermeasures are unnecessary. In a case in which the detection signal of the first detector is able to rise sharply, the detection speed increases.

The expression is

$$\frac{d P ( {R}_{1} )}{d {R}_{1}} > P ( {R}_{1} ) \qquad [ Math . 7 ]$$

and the reflectivity R₁ of the first reflection surface increases due to the reactant reacting. Alternatively, the expression is

$$\frac{d P ( {R}_{1} )}{d {R}_{1}} < - P ( {R}_{1} ) \qquad [ Math . 8 ]$$

and the reflectivity R₁ of the first reflection surface decreases due to the reactant reacting. With the above configuration, because the light intensity of light detected by the first detector increases as the reactant reacts, the S/N increases. Because it is possible to set the light intensity detected by the detector before reaction to a small value, it is possible to reduce the driving energy of the light emitting device, thereby reducing the amount of power consumed. In increasing or decreasing the reflectivity R₁ of the first reflection surface due to reacting, the material and film thickness of the reactant may be selected, as appropriate, according to the coating state of the first reflection surface.

The expression is

$$\frac{d P ( {R}_{1} )}{d {R}_{1}} > P ( {R}_{1} ) \qquad [ Math . 7 ]$$

and the reflectivity R₁ of the first reflection surface decreases due to the reactant reacting. Alternatively, the expression is

$$\frac{d P ( {R}_{1} )}{d {R}_{1}} < - P ( {R}_{1} ) \qquad [ Math . 8 ]$$

and the reflectivity R₁ of the first reflection surface increases due to the reactant reacting. With the above configuration, because the light intensity lowers as the reactant reacts, it is possible to perform circuit modulation so that the sensitivity of the first detector itself becomes the maximum in the state before reaction without saturating the detection intensity even if the reaction proceeds. Thus, in particular, it is possible to increase the S/N in a region with a minute variation amount, thus enabling highly sensitive detection.

The above-described optical sensor system further includes control means for performing feedback control based on the light intensity detected by the first detector such that the light intensity detected by the first detector becomes constant. With the above configuration, because the light intensity at which the reactant is irradiated becomes constant, the reaction temperature of the reactant is substantially constant. If there is an action such that reaction of the reactant increases the light intensity of light radiated from the first reflection surface, because control is performed such that the injection current to the light emitting device is gradually reduced so that the light intensity is not increased, it is possible for the consumed power to be reduced.

The above-described optical sensor system further includes a second detector that detects the light intensity of light emitted from the other of the first reflection surface and the second reflection surface. With the above configuration, if one of the light intensity of light radiated from the first reflection surface and the light intensity of light radiated from the second reflection surface is increased due to the reactant reacting and one is reduced, the detector in which the detection intensity is reduced as the reaction of the reactant proceeds is able to perform circuit modulation so that the sensitivity of the detector becomes the maximum in the state before reaction without saturating the detection intensity due to the reacting, and the S/N increases for the detector in which the detection intensity increases as the reaction of the reactant proceeds. That is, it is possible for these two effects to be combined. By making either one of the detectors high sensitivity and the other detector low sensitivity, it is possible for the detection speed as an optical sensor system in the high sensitivity detector to be increased and for the measurement range of environmental parameters in the low sensitivity to be widened. That is, it is possible for a high sensitivity, high speed, wide range optical sensor system to be obtained.

The optical sensor head according to Embodiment 2 includes a light emitting device in which a first reflection surface, a second reflection surface that opposes the first reflection surface and a waveguide provided between the first reflection surface and the second reflection surface is formed; a light blocking film in which a through hole for generating near-field light is provided, and that is formed on the first reflection surface; and a detector that detects the light intensity of light emitted from the light emitting device through the first or second reflecting surface, in which an opening area of the through hole on the emission surface of light of the light blocking film is larger than the opening area of the through hole on the opposing surface of the light blocking film opposing the first reflection surface.

According to the configuration, because the intensity distribution of light in the through hole becomes weak in the vicinity of the emission surface of light and becomes strong in the vicinity of the opposing surface, detection is possible with a favorable sensitivity of refractive index variations only inside the through hole and that is not susceptible to influence from the outside of the through hole. Therefore, detection on the molecular level is possible if the opening size in the opposing surface of the through hole is made sufficiently small. In order to detect only the detection target able to enter the opening in the opposing surface of the through hole, it is possible to perform detection after sorting the detection target with the opening size. Since the detection target may only be present inside the through hole, it is possible to reduce sample volume. Size reductions are possible because a separate light source is made unnecessary.

The light blocking film is formed from a material that excites surface plasmons. According to the configuration, because the material of the light blocking film is a material that excites surface plasmons, the intensity of the near-field light generated in the through hole is strengthened, thereby the detection sensitivity increases.

The light emitted from the light emitting device is linearly polarized light; and the opening length of the through hole on the emission surface of the light blocking film related to the direction of the linearly polarized light is longer than the opening length of the through hole on the opposing surface of the light blocking film. According to the configuration, because the surface plasmons have the characteristics of being strongly excited in the surface orthogonal to the polarization direction of incident light, there is little influence from the outside of the through hole, and it is possible detect only the refractive index variations inside the through hole.

The light emitted from the light emitting device is linearly polarized light; and the opening length of the through hole relating to the direction of the linearly polarized light on the opposing surface of the light blocking film is shorter than the wavelength of the light emitted from the light emitting device. According to the configuration, almost no light is transmitted through the through hole, there is little influence from the outside of the through hole, and it is possible to detect only the refractive index inside the through hole.

The increase rate in the cross-sectional area of the through hole is continuous. According to the configuration, the detection target does not easily collect at the periphery of the emission surface of light, and smoothly enters until the opposing surface side with a strong intensity distribution of light. Therefore, even if the area in the opposing surface is small, it is possible to perform detection with sufficient sensitivity.

The increase rate in the cross-sectional area of the through hole is discontinuous. According to the configuration, it is possible to widen the range in which the intensity distribution of light inside the through hole is strong, and it is possible to increase the detection sensitivity.

A dielectric film formed between the light emitting device and the light blocking film is further provided, and a concavity connected to the through hole is formed in the dielectric film. According to the configuration, because the detection target is also present in the concavity formed in the dielectric film, it is possible for the sensitivity to be further raised.

The light emitting device is a semiconductor laser element. According to the configuration, it is possible to achieve a small optical sensor head and the calculation of the refractive index inside the through hole from the light intensity of light radiated to the outside through the first or second reflection surface detected by the detector is easy.

The detector is a spectroscope capable of spectrum measurement and detects the wavelength of light radiated to the outside through the first or second reflection surface. According to the configuration, because it is possible to uses the oscillation wavelength of the semiconductor laser depending on the environmental temperature, to calculate the environmental temperature from the calculated from the wavelength, and to correct the calculated refractive index, more accurate refractive index detection is possible.

The light blocking film is divided into two regions insulated from one another with the through hole as a boundary, and voltage application means for applying a voltage between the two regions of the light blocking film is further provided. According to the configuration, by applying a voltage between the two regions of the light blocking film, it is possible to collect the detection target inside the through hole. Therefore, the detection sensitivity is further improved.

The optical sensor system includes the optical sensor head, a calculator that calculates the refractive index in the through hole based on the detected value of the detector when the light emitting device emits light, and a display unit that displays the refractive index calculated by the calculator. According to the configuration, the optical sensor system is not susceptible to influence from the outside of the through hole, able to detect only the refractive index variations inside the through hole, and is also capable of molecular level detection. In obtaining the detection value, it is preferable that the light emitting device emits light with at least two current values.

The present invention is not limited to the above-described embodiments with various modifications being possible in the range disclosed in the claims, and embodiments obtained by appropriate combination of the technical means disclosed in each of the different embodiments are also included in the technical range of the present invention. Furthermore, it is possible to form new technical characteristics through combination of the technical means disclosed in each of the embodiments.

### REFERENCE SIGNS LIST

1 OPTICAL SENSOR HEAD
2 LIGHT EMITTING DEVICE
3 DETECTOR
4 FIRST REFLECTION SURFACE
5 SECOND REFLECTION SURFACE
6 WAVEGUIDE
7 LIGHT BLOCKING FILM
7a OPPOSING SURFACE
7b EMISSION SURFACE
8 THROUGH HOLE
9 DETECTION TARGET
10 FLOW CHANNEL
11 WINDOW
12 DIELECTRIC FILM
101 OPTICAL SENSOR HEAD
102 LIGHT EMITTING DEVICE
103a FIRST DETECTOR
103b SECOND DETECTOR
104 FIRST REFLECTION SURFACE
105 SECOND REFLECTION SURFACE
106 WAVEGUIDE
108 DRIVING CIRCUIT
109 TEMPERATURE SENSOR
120 REACTANT
151 CALCULATOR
152 DISPLAY UNIT
200 OPTICAL SENSOR SYSTEM

1-8. (canceled)

9. An optical sensor system, comprising:
a light emitting device that includes a first reflection surface, a second reflection surface that opposes the first reflection surface and a waveguide provided between the first reflection surface and the second reflection surface;
a reactant formed on the first reflection surface;
a first detector that detects a light intensity of light emitted from one of the first reflection surface and the second reflection surface;
a calculator that calculates environmental parameters in the first reflection surface based on the light intensity detected by the first detector; and
a second detector that detects the light intensity of light emitted from the other of the first reflection surface and the second reflection surface,
wherein the reflectivity R₁ of the first reflection surface and the light intensity P(R₁) detected by the detector satisfy the following relationship:
$$\vert \frac{d P ( {R}_{1} )}{d {R}_{1}} \vert > P ( {R}_{1} ) . \qquad [ Math . 1 ]$$

10. The optical sensor system according to claim 9, further comprising:
control means for performing feedback control based on the light intensity detected by the first detector such that the light intensity detected by the first detector becomes constant.

11. An optical sensor head comprising:
a light emitting device in which a first reflection surface, a second reflection surface that opposes the first reflection surface and a waveguide provided between the first reflection surface and the second reflection surface is formed;
a light blocking film in which a through hole for generating near-field light is provided, and that is formed on the first reflection surface; and
a detector that detects the light intensity of light emitted from the light emitting device through the first or second reflecting surface,
wherein an opening area of the through hole on the emission surface of light of the light blocking film is larger than the opening area of the through hole on the opposing surface of the light blocking film opposing the first reflection surface.

12. The optical sensor head according to claim 11,
wherein the light blocking film is formed from a material that excites surface plasmons.

13. The optical sensor head according to claim 12,
wherein the light emitted from the light emitting device is linearly polarized light; and
an opening length of the through hole on the emission surface of the light blocking film related to the direction of the linearly polarized light is longer than the opening length of the through hole on the opposing surface of the light blocking film.

14. The optical sensor head according to claim 11,
wherein the light emitted from the light emitting device is linearly polarized light; and
the opening length of the through hole relating to the direction of the linearly polarized light on the opposing surface of the light blocking film is shorter than the wavelength of the light emitted from the light emitting device.

15. An optical sensor system comprising:
the optical sensor head according to claim 11,
a calculator that calculates the refractive index in the through hole based on the detected value of the detector when the light emitting device emits light; and
a display unit that displays the refractive index calculated by the calculator.
